(19) United States
(12) Patent Application Publication
(10) Pub. No.: US 2026/0045863 A1
(43) Pub. Date: Feb. 12, 2026

(54) PERMANENT MAGNET-ASSISTED SYNCHRONOUS RELUCTANCE MOTOR IN A POWER TOOL

(71) Applicant: MILWAUKEE ELECTRIC TOOL CORPORATION, Brookfield, WI (US)

(72) Inventors: Ashad Farhan, Brookfield, WI (US); Keith Boulanger, Twin Lakes, WI (US)

(21) Appl. No.: 18/998,987

(22) PCT Filed: Aug. 2, 2023
(86) PCT No.: PCT/US2023/029272

§ 371 Date: Jan. 27, 2025

Related U.S. Application Data
(60) Provisional application No. 63/370,197, filed on Aug. 2, 2022.
(60) Provisional application No. 63/503,516, filed on May 22, 2023.

(51) Int. Cl. H02K 21/16; B25F 5/02; H02K 7/14

(52) U.S. Cl. CPC H02K 21/16; B25F 5/02; H02K 7/145

(57) ABSTRACT

A power tool includes a permanent magnet assisted synchronous rotor motor. The motor includes a stator and a rotor. The rotor includes a first slot located between an external circumferential surface of the rotor. The first slot includes a first magnet housing portion. The first magnet housing portion located a first radial distance away from a center of rotation of the rotor. The rotor includes a second slot located between the external circumferential surface of the rotor and the first slot. The second slot includes a second magnet housing portion. A second length of the second slot is shorter than a first length of the first slot, and the second magnet housing is located a second radial distance away from the center of rotation of the rotor.

### RELATED APPLICATIONS

This application claims the benefit of U.S. Provisional Patent Application No. 63/370,197, filed Aug. 2, 2022, and U.S. Provisional Patent Application No. 63/503,516, filed May 22, 2023, the entire content of each of which is hereby incorporated by reference.

### FIELD

Embodiments described herein relate to a motor of a power tool.

### SUMMARY

Power tools described herein include a battery pack interface configured to receive a removable and rechargeable battery pack and a permanent magnet assisted synchronous rotor motor. The motor includes a stator including a plurality of stator teeth configured to receive a plurality of stator coils and a rotor. The rotor includes a first slot located between an external circumferential surface of the rotor. The first slot includes a first magnet housing portion. The first magnet housing portion has a first width and a first length. The first magnet housing portion located a first radial distance away from a center of rotation of the rotor. The rotor includes a second slot located between the external circumferential surface of the rotor and the first slot. The second slot includes a second magnet housing portion. The second magnet housing portion has a second width and a second length. The second length of the second slot is shorter than the first length of the first slot, and the second magnet housing is located a second radial distance away from the center of rotation of the rotor. The rotor includes a first magnet within the first magnet housing portion. The first magnet has a first magnet length and a first magnet width. The rotor includes a second magnet within the second magnet housing. The second magnet has a second magnet length and a second magnet width. The first magnet fills at least 60% of the first magnet housing portion and the second magnet fills at least 60% of the second magnet housing portion. The first magnet fills at least as much of the first magnet housing portion as the second magnet fills the second magnet housing portion.

In some embodiments, the stator includes at least twelve stator slots and the rotor includes at least four rotor poles.

In some embodiments, the first magnet is composed of a ferrite metal material and the second magnet is composed of a rare earth metal material.

In some embodiments, the second magnet fills a greater percentage of the second magnet housing portion than the first magnet fills the first magnet housing portion.

In some embodiments, the power tool of further includes a first steel rib associated with the first slot: and a second steel rib associated with the second slot.

Power tools described herein include a battery pack interface configured to receive a removable and rechargeable battery pack, a permanent magnet assisted synchronous rotor motor including a stator including a plurality of stator teeth configured to receive a plurality of stator coils, and a rotor. The rotor includes a first slot located between an external circumferential surface of the rotor, the first slot including a first magnet housing portion, the first magnet housing portion having a first width and a first length, the first magnet housing portion located a first radial distance away from a center of rotation of the rotor, and a second slot located between the external circumferential surface of the rotor and the first slot, the second slot including a second magnet housing portion, the second magnet housing portion having a second width and a second length, the second length of the second slot being shorter than the first length of the first slot, and the second magnet housing located a second radial distance away from the center of rotation of the rotor. The rotor further includes a first magnet within the first magnet housing portion, the first magnet having a first magnet length and a first magnet width, a second magnet within the second magnet housing, the second magnet having a second magnet length and a second magnet width, and wherein the first magnet fills between 60% and 90% of the first magnet housing portion and the second magnet fills between 60% and 90% of the second magnet housing portion, and wherein the first magnet fills at least as much of the first magnet housing portion as the second magnet fills the second magnet housing portion.

In some embodiments, the stator includes at least eighteen stator slots and the rotor includes at least six rotor poles.

In some embodiments, the stator includes at least six stator slots and the rotor includes at least four rotor poles.

In some embodiments, the first magnet is composed of a ferrite metal material and the second magnet is composed of a rare earth metal material.

In some embodiments, the first magnet and the second magnet are composed of a rare earth metal material.

In some embodiments, the second magnet fills a greater percentage of the second magnet housing portion than the first magnet fills the first magnet housing portion.

Power tools described herein include a battery pack interface configured to receive a removable and rechargeable battery pack and a permanent magnet assisted synchronous rotor motor including a stator including a plurality of stator teeth configured to receive a plurality of stator coils and a rotor. The rotor includes a first slot located between an external circumferential surface of the rotor, the first slot including a first magnet housing portion, the first magnet housing portion having a first width and a first length, the first magnet housing portion located a first radial distance away from a center of rotation of the rotor, and a second slot located between the external circumferential surface of the rotor and the first slot, the second slot including a second magnet housing portion, the second magnet housing portion having a second width and a second length, the second length of the second slot being shorter than the first length of the first slot, and the second magnet housing located a second radial distance away from the center of rotation of the rotor. The rotor further includes a first magnet within the first magnet housing portion, the first magnet having a first magnet length and a first magnet width, a second magnet within the second magnet housing, the second magnet having a second magnet length and a second magnet width, a first steel rib configured to fill a portion of the first magnet housing portion, a second steel rib configured to fill a portion of the second magnet housing portion, and wherein the first magnet fills least 60% of the first magnet housing portion and the second magnet fills at least 60% of the second magnet housing portion, and wherein the first magnet fills at least as much of the first magnet housing portion as the second magnet fills the second magnet housing portion.

In some embodiments, the first steel rib is positioned at the center of the first magnet housing portion and the second steel rib is positioned at the center of the second magnet housing portion.

In some embodiments, the power tool further comprising a third steel rib and a fourth steel rib.

In some embodiments, the first steel rib is configured to be positioned between a first arm of the first slot and the first magnet housing portion, the second steel rib is configured to be positioned between a second arm of the first slot and the first magnet housing portion, the third steel rib is configured to be positioned between a first arm of the second slot and the second magnet housing portion, and wherein the fourth steel rib is configured to be positioned between a second arm of the second slot and the second magnet housing portion.

Power tools described herein include a battery pack interface configured to receive a removable and rechargeable battery pack and a permanent magnet assisted synchronous rotor motor including a stator including a plurality of stator teeth configured to receive a plurality of stator coils and a rotor. The rotor comprises a first radial distance away from a center of rotation of the rotor, the first radial distance being no more than 90% of a radius of a stator outer diameter, a first slot located between an external circumferential surface of the rotor, the first slot including a first magnet housing portion, the first magnet housing portion having a first width and a first length, the first magnet housing portion located a second radial distance away from a center of rotation of the rotor. The rotor further comprises a second slot located between the external circumferential surface of the rotor and the first slot, the second slot including a second magnet housing portion, the second magnet housing portion having a second width and a second length, the second length of the second slot being shorter than the first length of the first slot, and the second magnet housing located a third radial distance away from the center of rotation of the rotor, a first magnet within the first magnet housing portion, the first magnet having a first magnet length and a first magnet width, a second magnet within the second magnet housing, the second magnet having a second magnet length and a second magnet width, and wherein the first magnet fills between 30% and 90% of the first magnet housing portion and the second magnet fills between 30% and 90% of the second magnet housing portion, wherein the second radial distance away from a center of rotation of the rotor is between 50% and 95% of first radial distance, and the third radial distance away from the center of rotation of the rotor is between 50% and 95% of first radial distance, and wherein the second radial distance is greater than the third radial distance.

In some embodiments, the first length is between approximately two times an airgap thickness and 50% of the first radial distance, and the first width is between approximately 2.5% and 200% of the magnet housing width, and the second width is between 0.5 times to 10 times the airgap thickness.

In some embodiments, the first magnet fills 90% of the first magnet housing portion and the second magnet fills 90% of the second magnet housing portion.

Power tools described herein include a battery pack interface configured to receive a removable and rechargeable battery pack, and a permanent magnet assisted synchronous rotor motor including a stator including an inner diameter and a plurality of stator teeth configured to receive a plurality of stator coils, and a rotor. The rotor includes an airgap thickness, the airgap thickness including a distance between an rotor outer diameter and the stator inner diameter, a first slot, the first slot including a first arm, a second arm, and a first magnet housing portion positioned therebetween, wherein the first arm includes a first length between two times the airgap thickness and 50% of a rotor radial distance and a first width between 2.5% and 200% of a width of the first magnet housing portion, and wherein the second arm includes a second length between two times the airgap thickness and 50% of a rotor radial distance and a second width between 2.5% and 200% of the width of the first magnet housing portion.

In some embodiments, the rotor further includes a second slot, the second slot including a third arm, a fourth arm, and a second magnet housing portion positioned therebetween, wherein the third arm includes a third length between two times the airgap thickness and 50% of a rotor radial distance and a third width between 2.5% and 200% of a width of the second magnet housing portion, and wherein the fourth arm includes a fourth length between two times the airgap thickness and 50% of a rotor radial distance and a fourth width between 2.5% and 200% of the width of the second magnet housing portion.

In some embodiments, the stator further includes a diameter of approximately 80 millimeters. In some embodiments, the rechargeable battery pack includes a maximum voltage of approximately 83.5 Volts.

In some embodiments, the stator further includes a stator slot fill for a stator winding, the stator slot fill filling approximately 42% of the stator winding.

In some embodiments, the permanent magnet assisted synchronous rotor motor further includes a phase winding having a resistance between 0.11 Ohms and 0.15 Ohms.

In some embodiments, the rotor further includes a first magnet within the first magnet housing portion, the first magnet composed of a ferrite metal material and a second magnet within the second magnet housing, the second magnet composed of a rare earth metal material.

In some embodiments, the stator includes at least eighteen stator slots and the rotor includes at least six rotor poles.

In some embodiments, the stator includes at least six stator slots and the rotor includes at least four rotor poles.

Power tools described herein include a battery pack interface configured to receive a removable and rechargeable battery pack and a permanent magnet assisted synchronous rotor motor including a stator. The stator includes a plurality of stator teeth configured to receive a plurality of stator coils, a plurality of stator winding slots, the plurality of stator winding slots including an outer stator winding circumference and an inner stator winding circumference displaced from one another by a stator winding radius, and a plurality of stator windings configured to be wound around one or more of the plurality of stator teeth. The power tool further includes a rotor including a first radial distance away from a center of rotation of the rotor, the first radial distance being no more than 90% of a radius of a stator outer diameter, a first slot located between an external circumferential surface of the rotor, the first slot including a first magnet housing portion, the first magnet housing portion having a first width and a first length, the first magnet housing portion located a second radial distance away from a center of rotation of the rotor, a first magnet within the first magnet housing portion, wherein the first magnet fills between 80% and 100% of the first magnet housing portion.

In some embodiments, an outer diameter of the motor is between 60 millimeters and 65 millimeters.

In some embodiments, an outer diameter of the motor is 63 millimeters.

In some embodiments, the plurality of stator windings are configured as distributed windings.

In some embodiments, the plurality of stator windings are configured as concentrated windings.

In some embodiments, the plurality of stator windings are configured to be evenly distributed around a circumference of the stator core.

In some embodiments, the plurality of stator windings are configured to be distributed to reduce harmonic distortion within the permanent magnet assisted synchronous rotor motor.

In some embodiments, the plurality of stator windings are configured to be distributed to provide a uniform distribution of magnetic flux.

In some embodiments the rotor further includes a second slot located between the external circumferential surface of the rotor and the first slot, the second slot including a second magnet housing portion, the second magnet housing portion having a second width and a second length, the second length of the second slot being shorter than the first length of the first slot, and the second magnet housing located a third radial distance away from the center of rotation of the rotor, a second magnet within the first magnet housing portion, wherein the second magnet fills between 80% and 100% of the first magnet housing portion, wherein the second radial distance away from a center of rotation of the rotor is between 50% and 95% of first radial distance, and the third radial distance away from the center of rotation of the rotor is between 50% and 95% of first radial distance, and wherein the second radial distance is greater than the third radial distance.

In some embodiments, the first magnet fills approximately 100% of the first magnet housing portion, and the second magnet fills approximately 100% of the second magnet housing portion.

In some embodiments, the first magnet is composed of a ferrite metal material, and the second magnet is composed of a rare earth metal material.

In some embodiments, the first slot further includes a first arm, a second arm, the first magnet housing portion positioned therebetween, wherein the first arm includes a first length between two times an airgap thickness and 50% of a rotor radial distance and a first width between 2.5% and 200% of a width of the first magnet housing portion, and the second arm includes a second length between two times the airgap thickness and 50% of a rotor radial distance and a second width between 2.5% and 200% of the width of the first magnet housing portion.

In some embodiments, the second slot further includes a third arm, a fourth arm, the second magnet housing portion positioned therebetween, wherein the third arm includes a third length between two times the airgap thickness and 50% of a rotor radial distance and a third width between 2.5% and 200% of a width of the second magnet housing portion, and wherein the fourth arm includes a fourth length between two times the airgap thickness and 50% of a rotor radial distance and a fourth width between 2.5% and 200% of the width of the second magnet housing portion.

Before any embodiments are explained in detail, it is to be understood that the embodiments are not limited in application to the details of the configurations and arrangements of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including.” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

Unless the context of their usage unambiguously indicates otherwise, the articles “a.” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices.” “controllers.” “processors,” etc., described in the specification can include one or more processing units, one or more computer-readable medium modules, one or more input/output interfaces, and various connections (e.g., a system bus) connecting the components.

Relative terminology, such as, for example, “about.” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

Other aspects of the embodiments will become apparent by consideration of the detailed description and accompanying drawings.

### BRIEF DESCRIPTION OF THE DRAWINGS

FIG. 1 illustrates a side view of a power tool in accordance with some embodiments.

FIG. 2 illustrates a block diagram of a control system of the power tool of FIG. 1 in accordance with some embodiments.

FIG. 3 illustrates a battery pack for use with the power tool of FIG. 1 in accordance with some embodiments.

FIG. 4 illustrates a block diagram of a control system of the battery pack of FIG. 3 in accordance with some embodiments.

FIG. 5 illustrates an internal permanent magnet motor according to some embodiments.

FIG. 6 illustrates a permanent magnet-assisted synchronous reluctance motor according to some embodiments.

FIG. 7 illustrates a permanent magnet-assisted synchronous reluctance motor according to some embodiments.

FIG. 8 illustrates a permanent magnet-assisted synchronous reluctance motor including magnets made of two different materials according to some embodiments.

FIG. 9A is a graphical representation of efficiency, electrical current, and speed operating curves of various motors in accordance with some embodiments.

FIG. 9B is a graphical representation of efficiency, electrical current, and speed operating curves of various motors in accordance with some embodiments.

FIG. 10 illustrates a surface-mounted permanent magnet motor according to some embodiments.

FIG. 11 illustrates a permanent magnet-assisted synchronous reluctance motor according to some embodiments.

FIG. 12 illustrates a permanent magnet-assisted synchronous reluctance motor according to some embodiments.

FIG. 13 illustrates a permanent magnet-assisted synchronous reluctance motor including magnets made of two different materials according to some embodiments.

FIG. 14 is a graphical representation of efficiency, electrical current, and speed operating curves of various motors in accordance with some embodiments.

FIG. 15 illustrates an internal permanent magnet motor according to some embodiments.

FIG. 16 illustrates a permanent magnet-assisted synchronous reluctance motor according to some embodiments.

FIG. 17 illustrates a permanent magnet-assisted synchronous reluctance motor including magnets made of two different materials, according to some embodiments.

FIG. 18 is a graphical representation of efficiency, electrical current, and speed operating curves of various motors in accordance with some embodiments.

FIG. 19 illustrates a permanent magnet-assisted synchronous reluctance motor including ribs according to some embodiments.

FIG. 20 illustrates a permanent magnet-assisted synchronous reluctance motor including ribs according to some embodiments.

FIG. 21 illustrates an internal permanent magnet motor according to some embodiments.

FIG. 22 illustrates a permanent magnet-assisted synchronous reluctance motor including distributed windings according to some embodiments.

FIG. 23 illustrates a permanent magnet-assisted synchronous reluctance motor including concentrated windings according to some embodiments.

FIG. 24 is a graphical representation of efficiency, electrical current, speed, and output power operating curves of various motors in accordance with some embodiments.

### DETAILED DESCRIPTION

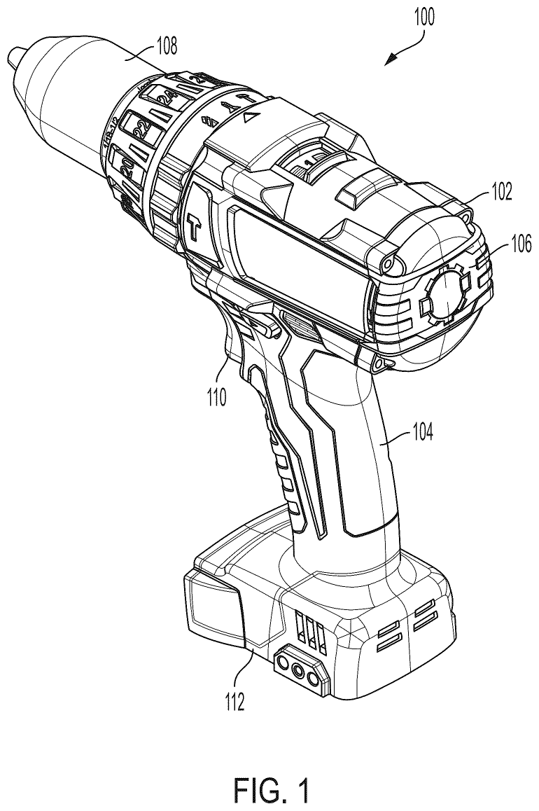

FIG. 1 illustrates a power tool 100 including a permanent magnet-assisted synchronous reluctance motor. The power tool 100 is, for example, a hammer drill including a housing 102. The housing 102 includes a handle portion 104 and motor housing portion 106. The power tool 100 further includes an output driver 108 (illustrated as a chuck), a trigger 110, and a battery pack interface 112. The battery pack interface 112 is configured to mechanically and electrically connect to or receive a power tool battery pack. Although FIG. 1 illustrates a hammer drill, in some embodiments, the components described herein are incorporated into other types of power tools including drill-drivers, impact drivers, impact wrenches, angle grinders, circular saws, reciprocating saws, plate compactors, core drills, string trimmers, leaf blowers, vacuums, and the like. In a permanent magnet-assisted synchronous reluctance motor power tool, such as power tool 100, switching elements are selectively enabled and disabled by control signals from a controller to selectively apply power from a power source (e.g., battery pack) to drive a permanent magnet-assisted synchronous reluctance motor.

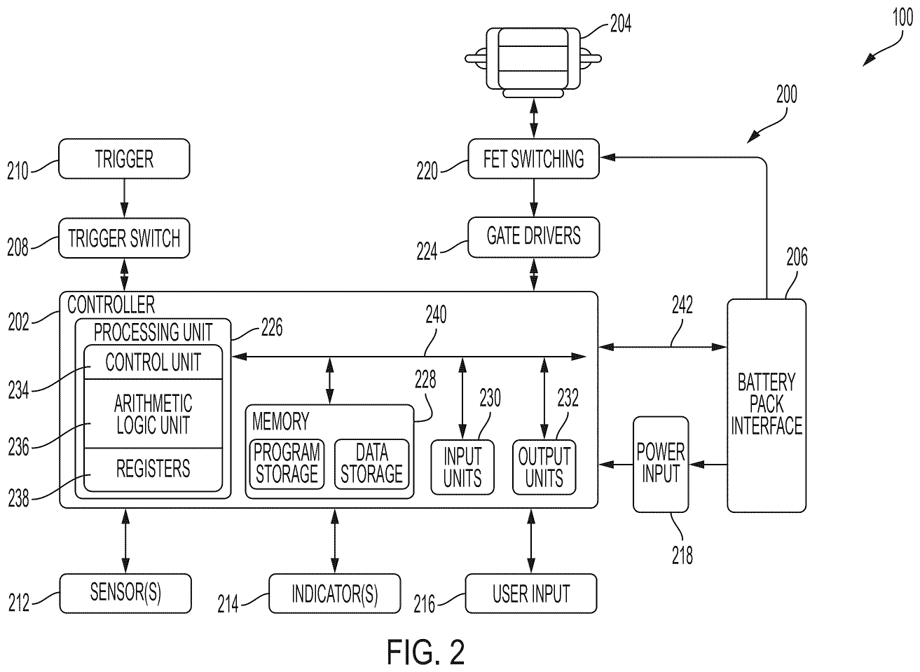

FIG. 2 illustrates a control system 200 for the power tool 100. The control system 200 includes a controller 202. The controller 202 is electrically and/or communicatively connected to a variety of modules or components of the power tool 100. For example, the illustrated controller 202 is electrically connected to a motor 204, a battery pack interface 206, a trigger switch 208 (connected to a trigger 210), one or more sensors or sensing circuits 212, one or more indicators 214, a user input module 216, a power input module 218, an inverter bridge or FET switching module 220 (e.g., including a plurality of switching FETs), and gate drivers 224 for driving the FET switching module 220. In some embodiments, motor 204 is a permanent magnet-assisted synchronous reluctance motor. The controller 202 includes combinations of hardware and software that are operable to, among other things, control the operation of the power tool 100, monitor the operation of the power tool 100, activate the one or more indicators 214 (e.g., an LED), etc.

The controller 202 includes a plurality of electrical and electronic components that provide power, operational control, and protection to the components and modules within the controller 202 and/or the power tool 100. For example, the controller 202 includes, among other things, a processing unit 226 (e.g., a microprocessor, a microcontroller, an electronic controller, an electronic processor, or another suitable programmable device), a memory 228, input units 230, and output units 232. The processing unit 226 includes, among other things, a control unit 234, an arithmetic logic unit (“ALU”) 236, and a plurality of registers 238, and is implemented using a known computer architecture (e.g., a modified Harvard architecture, a von Neumann architecture, etc.). The processing unit 226, the memory 228, the input units 230, and the output units 232, as well as the various modules or circuits connected to the controller 202 are connected by one or more control and/or data buses (e.g., common bus 240). The control and/or data buses are shown generally in FIG. 2 for illustrative purposes. The use of one or more control and/or data buses for the interconnection between and communication among the various modules, circuits, and components would be known to a person skilled in the art in view of the invention described herein.

The memory 228 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 226 is connected to the memory 228 and executes software instructions that are capable of being stored in a RAM of the memory 228 (e.g., during execution), a ROM of the memory 228 (e.g., on a generally permanent basis), or another non-transitory computer readable medium such as another memory or a disc. Software included in the implementation of the power tool 100 can be stored in the memory 228 of the controller 400. The software includes, for example, firmware, one or more applications, program data, filters, rules, one or more program modules, and other executable instructions. The controller 202 is configured to retrieve from the memory 228 and execute, among other things, instructions related to the control processes and methods described herein. In other constructions, the controller 202 includes additional, fewer, or different components.

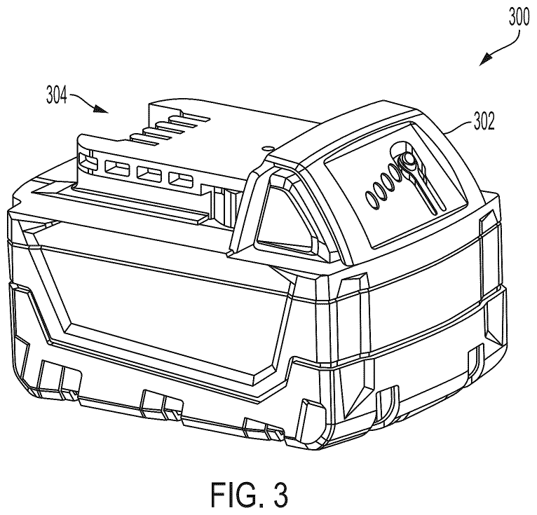

The battery pack interface 206 includes a combination of mechanical components (e.g., rails, grooves, latches, etc.) and electrical components (e.g., one or more terminals) configured to and operable for interfacing (e.g., mechanically, electrically, and communicatively connecting) with a battery pack. For example, power provided by a battery pack 300 (see FIG. 3) to the power tool 100 is provided through the battery pack interface 206 to the power input module 218. The power input module 218 includes combinations of active and passive components to regulate or control the power received from the battery pack 300 prior to power being provided to the controller 202. The battery pack interface 206 also supplies power to the FET switching module 220 to be switched by the switching FETs to selectively provide power to the motor 204. The battery pack interface 206 also includes, for example, a communication line 242 for providing a communication line or link between the controller 202 and the battery pack 300.

The sensors 212 include one or more current sensors, one or more speed sensors, one or more Hall effect sensors, one or more temperature sensors, etc. The indicators 214 include, for example, one or more light-emitting diodes (“LEDs”). The indicators 214 can be configured to display conditions of, or information associated with, the power tool 100. For example, the indicators 214 are configured to indicate measured electrical characteristics of the power tool 100, the status of the power tool, the status the motor 204, etc. The user input module 216 is operably coupled to the controller 202 to, for example, select a forward mode of operation or a reverse mode of operation, a torque and/or speed setting for the power tool 100 (e.g., using torque and/or speed switches), etc. In some embodiments, the user input module 216 includes a combination of digital and analog input or output devices required to achieve a desired level of operation for the power tool 100, such as one or more knobs, one or more dials, one or more switches, one or more buttons, etc.

FIG. 3 illustrates a battery pack 300. The battery pack 300 includes a housing 302 and an interface portion 304 for connecting the battery pack 300 to a power tool, such as the power tool 100.

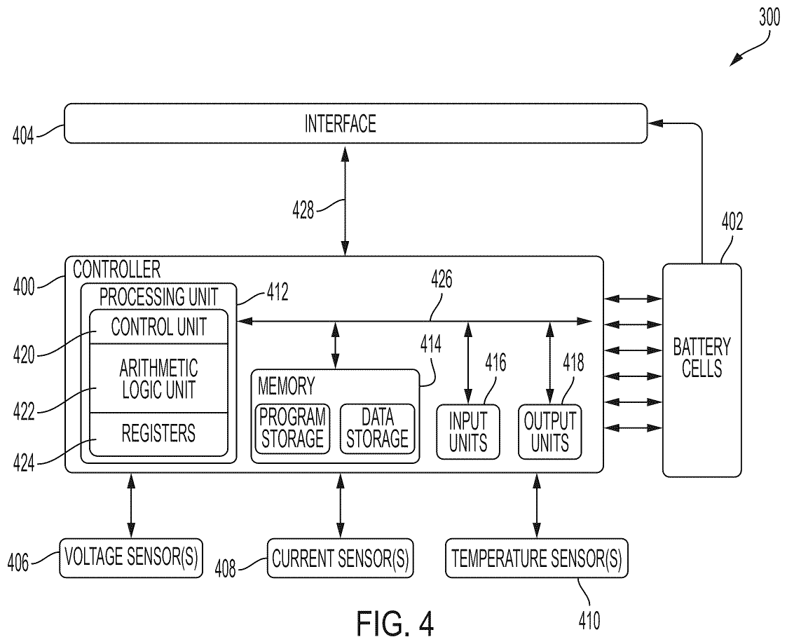

FIG. 4 illustrates a control system for the battery pack 300. The control system includes a controller 400. The controller 400 is electrically and/or communicatively connected to a variety of modules or components of the battery pack 300. For example, the illustrated controller 400 is connected to one or more battery cells 402 and an interface 404 (e.g., the interface portion 304 of the battery pack 300 illustrated in FIG. 3). The controller 400 is also connected to one or more voltage sensors or voltage sensing circuits 406, one or more current sensors or current sensing circuits 408, and one or more temperature sensors or temperature sensing circuits 410. The controller 400 includes combinations of hardware and software that are operable to, among other things, control the operation of the battery pack 300, monitor a condition of the battery pack 300, enable or disable charging of the battery pack 300, enable or disable discharging of the battery pack 300, etc.

The controller 400 includes a plurality of electrical and electronic components that provide power, operational control, and protection to the components and modules within the controller 400 and/or the battery pack 300. For example, the controller 400 includes, among other things, a processing unit 412 (e.g., a microprocessor, a microcontroller, an electronic processor, an electronic controller, or another suitable programmable device), a memory 414, input units 416, and output units 418. The processing unit 412 includes, among other things, a control unit 420, an ALU 422, and a plurality of registers 424, and is implemented using a known computer architecture (e.g., a modified Harvard architecture, a von Neumann architecture, etc.). The processing unit 412, the memory 414, the input units 416, and the output units 418, as well as the various modules or circuits connected to the controller 400 are connected by one or more control and/or data buses (e.g., common bus 426). The control and/or data buses are shown generally in FIG. 4 for illustrative purposes. The use of one or more control and/or data buses for the interconnection between and communication among the various modules, circuits, and components would be known to a person skilled in the art in view of the invention described herein.

The memory 414 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 412 is connected to the memory 414 and executes software instructions that are capable of being stored in a RAM of the memory 414 (e.g., during execution), a ROM of the memory 414 (e.g., on a generally permanent basis), or another non-transitory computer readable medium such as another memory or a disc. Software included in the implementation of the battery pack 300 can be stored in the memory 414 of the controller 400. The software includes, for example, firmware, one or more applications, program data, filters, rules, one or more program modules, and other executable instructions. The controller 400 is configured to retrieve from the memory 414 and execute, among other things, instructions related to the control processes and methods described herein. In other constructions, the controller 400 includes additional, fewer, or different components.

The interface 404 includes a combination of mechanical components (e.g., rails. grooves, latches, etc.) and electrical components (e.g., one or more terminals) configured to and operable for interfacing (e.g., mechanically, electrically, and communicatively connecting) the battery pack 300 with another device (e.g., a power tool, a battery pack charger, etc.). For example, the interface 404 is configured to communicatively connect to the controller 400 via a communications line 428.

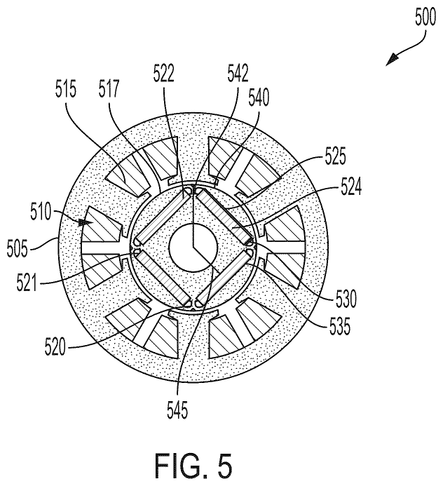

FIG. 5 illustrates an internal permanent magnet motor 500. The internal permanent magnet motor 500) includes a stator 505 and a plurality of stator winding slots 510. The plurality of stator winding slots 510 are configured to receive a plurality of windings 515. The internal permanent magnet motor 500 includes a rotor 517. The rotor 517 includes a circumferential outside surface 540 spaced a first radial distance 542 away from the center of rotation of the rotor 517. The rotor 517 also includes a plurality of slots 535 configured to receive magnets. In some embodiments, slots 535 include a first arm 520 and a second arm 521, and a magnet housing portion 522 of the slots positioned therebetween. The magnet housing portion 522 is configured to be spaced a second radial distance 545 away from the center of rotation of the rotor 517. The magnet housing portions 522 are configured to receive a magnet 524 with a length 525 and a width 530. In some embodiments, the magnet 524 has a length 525 that fills approximately 100% of the magnet housing portion 522.

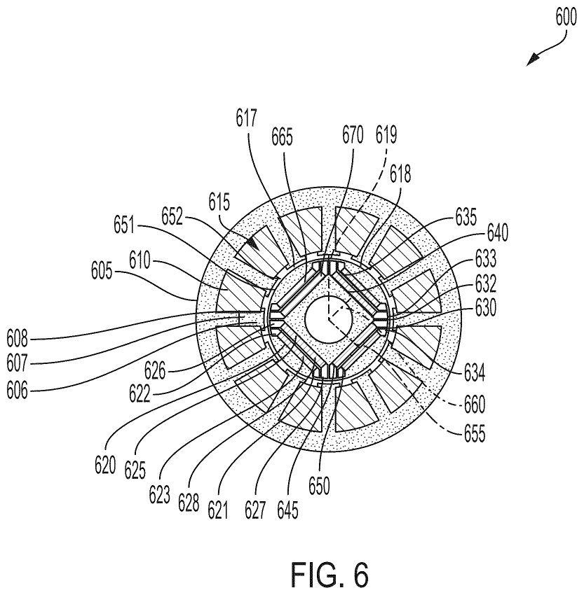

FIG. 6 illustrates a permanent magnet-assisted synchronous reluctance motor 600, according to some embodiments. The motor 600 includes a stator 605 and a plurality of stator winding slots 610. The stator 605 includes a plurality of stator teeth 606. The plurality of stator teeth include a stator tooth width 607 and a stator tooth length 608. The plurality of stator winding slots 610 are configured to receive a plurality of windings 615. The motor 600 includes a rotor 617. The rotor 617 includes a first slot 620 and second slot 625. The first slot 620 includes a first arm 621 and a second arm 622, and a first magnet housing portion 623 positioned therebetween. The second slot 625 includes a first arm 626 and a second arm 627, and a second magnet housing portion 628 positioned therebetween. The motor 600 can include pairs of first and second slots for each pole of the rotor 617 (e.g., four poles, six poles, etc.).

The rotor 617 includes a circumferential outside surface 618, spaced a first radial distance 619 away from the center of rotation of the rotor. In some embodiments, the first radial distance 619 is no more than 90% of a radius of the stator outer diameter. The first arm 621 of the first slot 620 includes a first width 634 and a first length 630. In some embodiments, the first width 634 is between 2.5% and 200% of the first magnet housing portion 623 first width 650, and the first length 630 is between Imm and 50% of the first radial distance 619. The first magnet housing portion 623 includes a first width 650 and a first length 635. In some embodiments, the first width 650 is between 0.5 times to 10 times an airgap thickness, and the first length 635 is greater than the stator tooth width 607. An airgap thickness is the distance between a rotor outer diameter 651 and a stator inner diameter 652. For instance, in some examples, the first width 650 is 2 times the airgap thickness. The first arm 626 of the second slot 625 includes a first width 633 and a first length 632. The second magnet housing portion 628 includes a first length 640 and a first width 645. In some embodiments, the first width 633 is between 2.5% and 200% of first width 645, and the first length 632 is between 2 times the airgap thickness and 50% of the first radial distance 619. In some embodiments, the first width 645 is between 0.5 times to 10 times an airgap thickness, and the first length 640 is greater than the stator tooth width 607.

In some embodiments, the first slot 620 is referred to as an outer slot, and the second slot 625 is referred to as an inner slot. In some embodiments, the first slot 620 and the second slot 625 are positioned at different radial distances from the center of rotation of rotor 617. For example, the first slot 620 is positioned at a second radial distance 655 from the center of rotation of the rotor 617. In some embodiments, the second radial distance 655 is no more than 50% to 95% of the first radial distance 619, and the second slot 625 is positioned a third radial distance 660 from the center of rotation. In some embodiments, the third radial distance is between 50% and 95% of the first radial distance 619, where the second radial distance 655 is greater than the third radial distance 660).

First magnet housing portion 623 is configured to receive a magnet, such as a magnet 665. In some embodiments, the magnet 665 is configured to fill approximately between 80% and 100% of the first magnet housing portion 623. Second magnet housing portion 628 is configured to receive a magnet, such as a magnet 670. In some embodiments, the magnet 670 is configured to fill approximately 100% of the second magnet housing portion 628. In some embodiments, the magnets 665 and 670 are rare earth magnets (e.g., neodymium magnets).

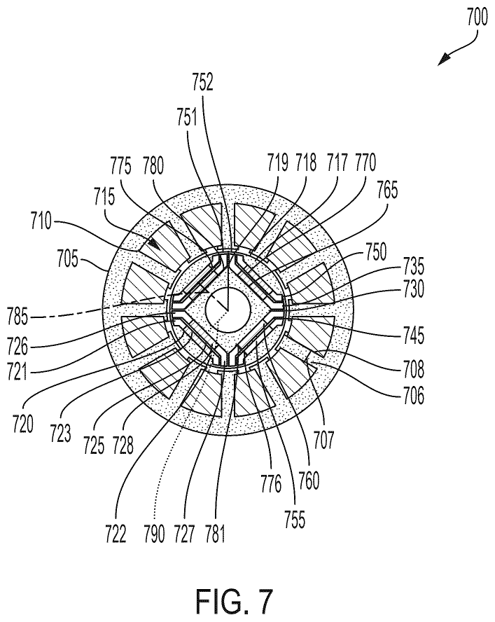

FIG. 7 illustrates a permanent magnet-assisted synchronous reluctance motor 700, according to some embodiments. The motor 700 includes a stator 705 and a plurality of stator winding slots 710. In some embodiments, stator 705 is configured to include at least twelve stator slots. The stator 705 includes a plurality of stator teeth 706. The plurality of stator teeth include a stator tooth width 707 and a stator tooth length 708. The plurality of stator winding slots 710 are configured to receive a plurality of windings 715. The motor 700 includes a rotor 717. The rotor 717 includes a circumferential outside surface 718 spaced a first radial distance 719 away from a center of rotation of the rotor 717. The first radial distance 719 is no more than 90% of a radius of the stator outer diameter of the stator 705. Rotor 717 includes a first slot 720 and a second slot 725. The first slot 720 includes a first arm 721 and a second arm 722, and a first magnet housing portion 723 is positioned therebetween. The second slot 725 includes a first arm 726 and a second arm 727, and a second magnet housing portion 728 is positioned therebetween. The motor 700 can include pairs of first and second slots for each pole of the rotor 717 (e.g., four poles, six poles, etc.).

The first arm 721 and the second arm 722 of the first slot 720 have a first length 745 and a first width 750. The first magnet housing portion 723 has a first magnet housing portion length 775 and a first magnet housing portion width 776. In some embodiments, the first length 745 is between 2 times the airgap thickness and 50% of the first radial distance 719, and the first width 750 is between 0.5 times to 10 times the airgap thickness. An airgap thickness is the distance between a rotor outer diameter 751 and a stator inner diameter 752. For instance, in some examples, the first length 745 is 2 times the airgap thickness. In some embodiments, the first magnet housing portion width 776 is between 0.5 times to 10 times the airgap thickness. In some embodiments, the first magnet housing portion length 775 is larger than the stator tooth width 707. In some embodiments, the first magnet housing portion 723 has a corresponding magnet fill or magnet fill percentage.

The first arm 726 and the second arm 727 of the second slot 725 have a first length 730 and a first width 735. In some embodiments, the first length 730 is 2 times the airgap thickness and 50% of the first radial distance 719, and the first width 735 is between 2.5% and 200% of the second magnet housing portion width 781. The second magnet housing portion 728 has a second magnet housing portion length 780 and a second magnet housing portion width 781. In some embodiments, the second magnet housing portion width 781 is between 0.5 times to 10 times the airgap thickness. In some embodiments, the second magnet housing portion length 780 is larger than the stator tooth width 707. In some embodiments, the second magnet housing portion 728 has a corresponding magnet fill or magnet fill percentage.

The first magnet housing portion 723 is configured to receive a magnet. In some embodiments, a magnet, such as a magnet 755, fills the first magnet housing portion 723 at least 30% of the first magnet housing portion 723 (e.g., 30% of the first magnet housing portion length 775). In some embodiments, the magnet 755 has a length 770 that is less than the total length of the first magnet housing portion length 775. In some embodiments, the magnet 755 fills between 60% and 90% of the first magnet housing portion 723.

The second magnet housing portion 728 is configured to receive a magnet, such as magnet 760. In some embodiments, similar to the first magnet housing portion 723, the second magnet housing portion 728 is configured to receive a magnet that fills the second magnet housing portion 728 at least 30% of the second magnet housing portion 728 (e.g., 30% of the second magnet housing portion length 780). In some embodiments, magnet 760 has a length 765 that is less than the length of the second magnet housing portion length 780. In some embodiments, the magnet 760 fills at least as much of the second magnet housing portion 728 as magnet 760 fills the first magnet housing portion 723. For example, the magnet 755 corresponds to a greater fill percentage of the first magnet housing portion 723 than the magnet 760 does of the second magnet housing portion 728. In some embodiments, the magnet 760 fills between 30% and 90% of the second magnet housing portion 728. In some embodiments, the magnets 755 and 760 are rare earth magnets (e.g., neodymium magnets).

In some embodiments, the first slot 720 is referred to as an outer slot, and the second slot 725 is referred to as an inner slot. In some embodiments, the first slot 720 and the second slot 725 are positioned at different radial distances from the center of rotation of rotor 717. For example, the first slot 720 is positioned at a second radial distance 785 from the center of rotation of the rotor 717. In some embodiments, the second radial distance 785 is between 50% and 95% of first radial distance 719, and the second slot 725 is positioned a third radial distance 790 from the center of rotation. In some embodiments, the third radial distance 790 is between 50% and 95% of first radial distance 719, and the second radial distance 785 is greater than the third radial distance 790. In some embodiments, the rotor 717 includes at least four rotor poles.

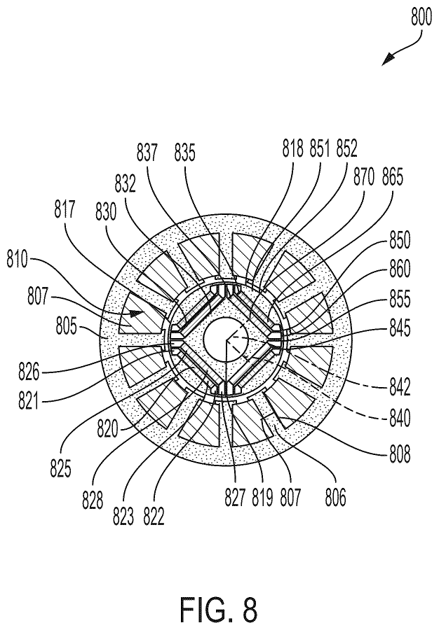

FIG. 8 illustrates a permanent magnet-assisted synchronous reluctance motor 800, according to some embodiments. The motor 800 includes a stator 805 and a plurality of stator winding slots 810. The stator 805 includes a plurality of stator teeth 806. The plurality of stator teeth include a stator tooth width 807 and a stator tooth length 808. The plurality of stator winding slots 810 are configured to receive a plurality of windings 815. The motor 800 includes a rotor 817. The rotor 817 includes a circumferential outside surface 818 of rotor 817 spaced a first radial distance 819 away from the center of rotation of the rotor 817.

The rotor 817 includes a first slot 820 and a second slot 825. The first slot 820 includes a first arm 821 and a second arm 822, and a first magnet housing portion 823 is positioned therebetween. The second slot 825 includes a first arm 826 and a second arm 827, and a second magnet housing portion 828 is positioned therebetween. The first arm 821 and the second arm 822 of the first slot 820 have a first length 845 and a first width 850. In some embodiments, the first length 845 is between 2 times the airgap thickness and 50% of the first radial distance 819, and the first width 850 is between 2.5% and 200% of the first magnet housing portion width 835. The airgap thickness is the distance between a rotor outer diameter 851 and a stator inner diameter 852. For instance, in some examples, the first width 850 is 2 times the airgap thickness. The first arm 826 and the second arm 827 of the second slot 825 have a first length 855 and a first width 860. In some embodiments, the first length 855 is between 2 times the airgap thickness and 50% of the first radial distance 819, and the first width 860 is between 2.5% and 200% of the first magnet housing portion width 835.

The first magnet housing portion 823 has a first magnet housing portion length 830 and a first magnet housing portion width 835. In some embodiments, the first magnet housing portion length 830 is larger than the stator tooth width 807, and the first magnet housing portion width 835 is between 0.5 and 10 times the airgap thickness. The second magnet housing portion 828 has a second magnet housing portion length 832 and a second magnet housing portion width 837. In some embodiments, the second magnet housing portion length 832 is larger than the stator tooth width 807, and the second magnet housing portion width 837 is between 0.5 and 10 times the airgap thickness. In some embodiments, the first magnet housing portion length 830 is greater than the second magnet housing portion length 832.

In some embodiments, the first slot 820 is referred to as an outer slot, and the second slot 825 is referred to as an inner slot. In some embodiments, the first slot 820) and the second slot 825 are positioned at different radial distances from the center of rotation of rotor 817. The first magnet housing portion 823 is positioned a second radial distance 840) away from the center of rotation of the rotor 817, the second radial distance 840 being less than the first radial distance 819. In some embodiments, the first magnet housing portion 823 has a corresponding magnet fill or magnet fill percentage. The second magnet housing portion 828 is positioned a third radial distance 842 away from the center of rotation of the rotor 817, and the third radial distance 842 is less than the first radial distance 819 and the second radial distance 840. In some embodiments, the second magnet housing portion 828 has a corresponding magnet fill or magnet fill percentage.

The first magnet housing portion 823 is configured to receive a magnet, such as magnet 865. The second magnet housing portion 828 is configured to receive a magnet, such as magnet 870. In some embodiments, the magnet 865 is composed of rare earth metal materials, such as neodymium, and the magnet 870 is composed of ferrite materials. In some embodiments, the magnet 865 fills between 30% and 100% of the first magnet housing portion 823. In some embodiments, the magnet 865 fills between 30% and 80% of the first magnet housing portion 823. In some embodiments, the magnet 870 fills between 30% and 100% of the second magnet housing portion 828. In some embodiments, the magnet 870 fills between 30% and 80% of the second magnet housing portion 828. In some embodiments, the magnets 865 and 870 are rare earth magnets (e.g., neodymium magnets).

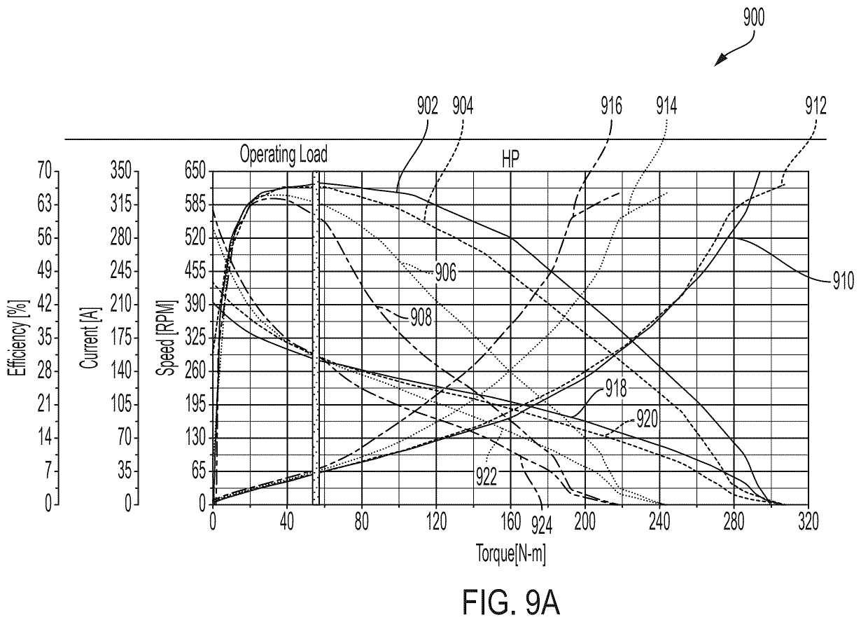

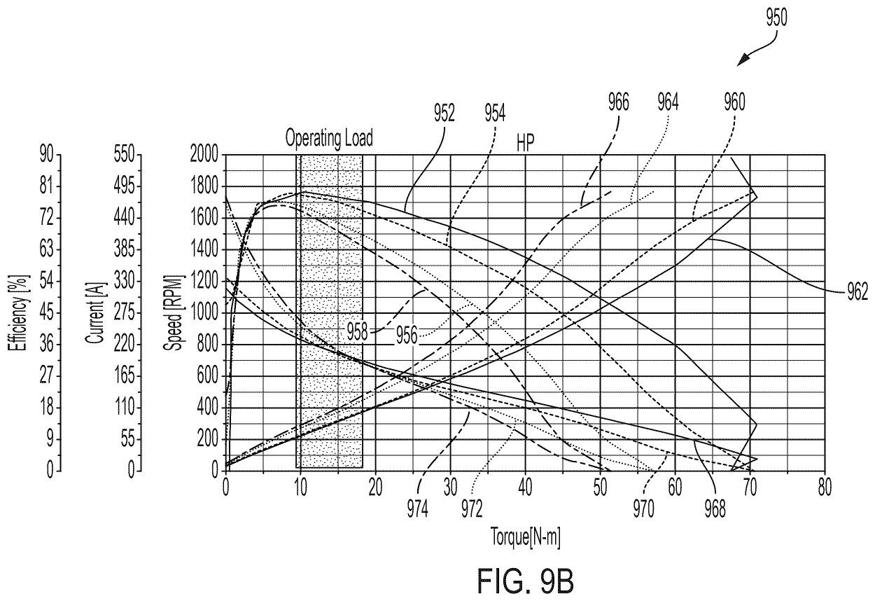

FIG. 9A is a graphical representation of efficiency, electrical current, and speed in revolutions per minute (“RPM”) compared to torque outputs of several different motors in the power tool 100, in accordance with some embodiments. In some embodiments, the motor represented in graph 900 is the motor of a core drill. The graph 900 includes a representation of the efficiency of several different motors within the power tool 100. A curve 902 illustrates an efficiency of one type of motor of the power tool 100, such as the motor 500. A curve 904 illustrates an efficiency of a second type of motor of the power tool 100, such as motor 600. A curve 906 illustrates an efficiency of a third type of motor of the power tool 100, such as motor 700. A curve 908 illustrates an efficiency of a fourth type of motor of the power tool 100, such as the motor 800. In some embodiments, the curve 902 is the efficiency of motor 500 as torque values increase. In some embodiments, the curve 904 is the efficiency of motor 600 as torque values increase. In some embodiments, the efficiency of motor 600 diminishes at a faster rate than motor 500 for a given torque value. In some embodiments, the curve 906 is the efficiency of motor 700 as torque values increase. In some embodiments. the efficiency of motor 700 diminishes at a faster rate than motor 500 and motor 600 for a given torque value. In some embodiments, the curve 908 is the efficiency of motor 800 as torque values increase. In some embodiments, the efficiency of motor 800 diminishes at a faster rate than motors 500, 600, and 700 for a given torque value.

Graph 900 additionally includes a representation of the electrical current of several different motors within the power tool 100. A curve 910 illustrates an electrical current of one type of motor of the power tool 100, such as motor 500. A curve 912 illustrates an electrical current of a second type of motor of the power tool 100, such as motor 600. A curve 914 illustrates an electrical current of a third type of motor of the power tool 100, such as motor 700. A curve 916 illustrates an electrical current of a fourth type of motor of the power tool 100, such as motor 800. In some embodiments, the curve 910 is the electrical current level of motor 500 as torque values increase. In some embodiments, the curve 912 is the electrical current of motor 600 as torque values increase. In some embodiments, as torque increases, the electrical current of both motor 500 and motor 600 is approximately equal for a given torque value. In some embodiments, the curve 914 is the electrical current of motor 700 as torque values increase. In some embodiments, as torque increases, the electrical current of motor 700 is greater than both motor 500 and 600 for a given torque value. In some embodiments, the curve 916 is the electrical current of motor 800 as torque values increase. In some embodiments, as torque increases, the electrical current of motor 800 is greater than motors 500, 600, and 700 for a given torque value.

Graph 900 additionally includes a representation of the RPM of several different motors within the power tool 100. A curve 918 illustrates an RPM of one type of motor of the power tool 100, such as motor 500. A curve 920 illustrates an RPM of a second type of motor of the power tool 100, such as motor 600. A curve 922 illustrates an RPM of a third type of motor of the power tool 100, such as motor 700. A curve 924 illustrates an RPM of a fourth type of motor of the power tool 100, such as motor 800. In some embodiments, the curve 918 is the RPM level of motor 500 as torque values increase. In some embodiments, the curve 920 is the RPM of motor 600 as torque values increase. In some embodiments, as torque increases, the RPM of motor 600 starts at a higher level and then diminishes at a faster rate than the RPM of motor 500 for a given torque value. In some embodiments, the curve 922 is the RPM of motor 700 as torque values increase. In some embodiments, as torque increases, the RPM of motor 700 starts at a higher level and then diminishes at a faster rate than the RPM of motor 500 and motor 600 for a given torque value. In some embodiments, the curve 924 is the RPM of motor 800 as torque values increase. In some embodiments, as torque increases, the RPM of motor 800 starts at a higher level and then diminishes faster than the RPM of motors 500, 600, and 700 for a given torque value. In some embodiments, for the operating load of the power tool 100, each motor operates at approximately the same speed.

In some embodiments, each of the motors 500, 600, 700, and 800 have stator diameters of 80 millimeters and are operated from a battery pack having a maximum voltage of approximately 83.5 V. In some embodiments, the stator slot fill for each stator winding is approximately 42% and a phase winding resistant is between 0.11 Ohms and 0.15 Ohms. Table 1 below provides relative performance data for the various motors. As illustrated below, only small reductions in run time and efficiency were observed compared to significant reductions in the amount of rare earth magnets (e.g., neodymium) used in the motors. For example, the motor 600 operated for the same amount of time (e.g., until battery pack was fully discharged), at the same speed, with the same efficiency, and with a 10% reduction in rare earth magnet mass. The motor 700 operated for 2% less time (e.g., until battery pack was fully discharged), at the same speed, with 3% reduced efficiency, and with a 38% reduction in rare earth magnet mass. The motor 800 operated for 7% less time (e.g., until battery pack was fully discharged), at the same speed, with 7% reduced efficiency, and with a 61% reduction in rare earth magnet mass.

TABLE 1
Motor Performance With Reduced Rare Earth Magnet Fill

| | Motor 500 | Motor 600 | Motor 700 | Motor 800 |
|---|---|---|---|---|
| Run Time | 100% | 100% | 98% | 93% |
| Application Speed | 290 RPM | 290 RPM | 290 RPM | 290 RPM |
| Efficiency | 67% | 67% | 64% | 63% |
| Magnet Mass | 100% | 90% | 62% | 39% |

FIG. 9B is a graphical representation of efficiency, electrical current, and speed in revolutions per minute (“RPM”) compared to torque outputs of several different motors in the power tool 100, in accordance with some embodiments. In some embodiments, the motor represented in graph 950 is the motor of a high torque impact wrench. The graph 950 includes a representation of the efficiency of several different motors within the power tool 100. A curve 952 illustrates an efficiency of one type of motor of the power tool 100, such as motor 500. A curve 954 illustrates an efficiency of a second type of motor of the power tool 100, such as motor 600. A curve 956 illustrates an efficiency of a third type of motor of the power tool 100, such as motor 700. A curve 958 illustrates an efficiency of a fourth type of motor of the power tool 100, such as motor 800. In some embodiments, the curve 952 is the efficiency of motor 500 as torque values increase. In some embodiments, the curve 954 is the efficiency of motor 600 as torque values increase. In some embodiments, the efficiency of motor 600 diminishes at a faster rate than motor 500 for a given torque value. In some embodiments, the curve 956 is the efficiency of motor 700 as torque values increase. In some embodiments, the efficiency of motor 700 diminishes at a faster rate than motor 500 and motor 600 for a given torque value. In some embodiments, the curve 958 is the efficiency of motor 800 as torque values increase. In some embodiments, the efficiency of motor 800 diminishes at a faster rate than motors 500, 600, and 700 for a given torque value.

The graph 950 additionally includes a representation of the electrical current of several different motors within the power tool 100. A curve 960 illustrates an electrical current of one type of motor of the power tool, such as motor 500. A curve 962 illustrates an electrical current of a second type of motor of the power tool 100, such as motor 600. A curve 964 illustrates an electrical current of a third type of motor of the power tool 100, such as motor 700. A curve 966 illustrates an electrical current of a fourth type of motor of the power tool 100, such as motor 800. In some embodiments, the curve 960 is the electrical current level of motor 500 as torque values increase. In some embodiments, the curve 962 is the electrical current of motor 600 as torque values increase. In some embodiments, the electrical current of the motor 500 is greater than the electrical current of the motor 600 for a given torque value. In some embodiments, the curve 964 is the electrical current of motor 700 as torque values increase. In some embodiments, the electrical current of motor 700 is greater than both motor 500 and 600 for a given torque value. In some embodiments, the curve 966 is the electrical current of motor 800 as torque values increase. In some embodiments, as torque increases, the electrical current of motor 800 is greater than motors 500. 600, and 700 for a given torque value.

The graph 950 additionally includes a representation of the RPM of several different motors within the power tool 100. A curve 968 illustrates an RPM of one type of motor of the power tool 100, such as motor 500. A curve 970 illustrates an RPM of a second type of motor of the power tool 100, such as motor 600. A curve 972 illustrates an RPM of a third type of motor of the power tool 100, such as motor 700. A curve 974 illustrates an RPM of a fourth type of motor of the power tool 100, such as the motor 800. In some embodiments, the curve 968 is the RPM level of motor 500 as torque values increase. In some embodiments, the curve 970 is the RPM of motor 600 as torque values increase. In some embodiments, the RPM of motor 600 starts higher and then diminishes at a faster rate than the RPM of motor 500 for a given torque value. In some embodiments, the curve 972 is the RPM of motor 700 as torque values increase. In some embodiments, the RPM of motor 700 starts higher and then diminishes at a faster rate than the RPM of motor 500 and motor 600 for a given torque value. In some embodiments, the curve 974 is the RPM of motor 800 as torque values increase. In some embodiments, the RPM of motor 800 starts higher and then diminishes faster than the RPM of motors 500, 600, and 700 for a given torque value. In some embodiments, for the operating load of the power tool 100, each motor operates at approximately the same speed.

In some embodiments, each of the motors 500, 600, 700, and 800 have stator diameters of 70 millimeters and are operated from a battery pack having a maximum voltage of approximately 20.4 V. In some embodiments, the stator slot fill for each stator winding is approximately 40% and a phase winding resistant is between 0.11 Ohms and 0.15 Ohms. Table 2 below provides relative performance data for the various motors. As illustrated below, only small reductions in run time and efficiency were observed compared to significant reductions in the amount of rare earth magnets (e.g., neodymium) used in the motors. For example, the motor 600 operated for the same amount of time (e.g., until battery pack was fully discharged), at the same speed, with 1% reduced efficiency, and with a 10% reduction in rare earth magnet mass. The motor 700 operated for 10% less time (e.g., until battery pack was fully discharged), at the same speed, with 4% reduced efficiency, and with a 36% reduction in rare earth magnet mass. The motor 800 operated for 14% less time (e.g., until battery pack was fully discharged), at the same speed, with 4% reduced efficiency, and with a 62% reduction in rare earth magnet mass.

TABLE 2
Motor Performance With Reduced Rare Earth Magnet Fill

| | Motor 500 | Motor 600 | Motor 700 | Motor 800 |
|---|---|---|---|---|
| Run Time | 100% | 100% | 90% | 86% |
| Application Speed | 780 RPM | 780 RPM | 780 RPM | 780 RPM |
| Efficiency | 78% | 77% | 74% | 74% |
| Magnet Mass | 100% | 90% | 64% | 38% |

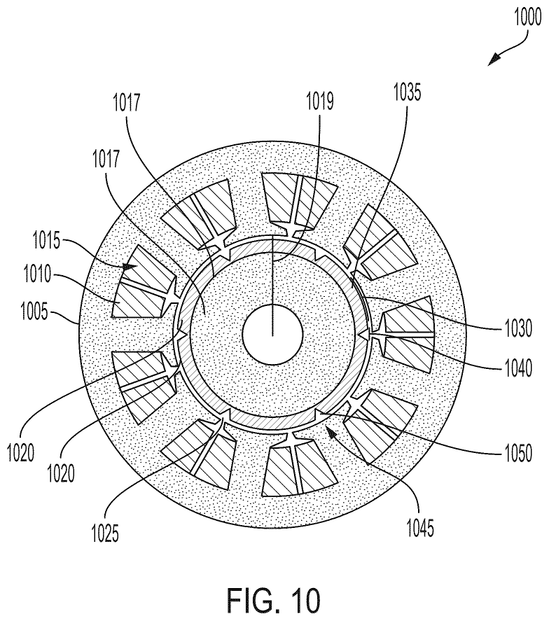

FIG. 10 illustrates a surface-mounted permanent magnet motor 1000, according to some embodiments. The motor 1000 includes a stator 1005 and a plurality of stator winding slots 1010. The plurality of stator winding slots 1010 are configured to receive a plurality of windings 1015. The motor 1000 includes a rotor 1017. The rotor 1017 includes a circumferential outside surface 1018 spaced a first radial distance 1019 away (including magnets) from the center of rotation of the rotor 1017. The rotor 1017 includes a plurality of magnets 1020 placed on the circumferential outside surface 1018 of the rotor. The plurality of magnets 1020 include slots 1025 spaced therebetween.

The plurality of magnets includes an outer surface 1030 spaced the first radial distance 1019 away from the center of rotation of the rotor 1017. Each outer surface 1030 of each magnet of the plurality of magnets is spaced apart by a first distance 1040. The plurality of slots expands outwardly from the circumferential outside surface 1018 of the rotor 1017 at a first angle 1045 for a second distance 1050.

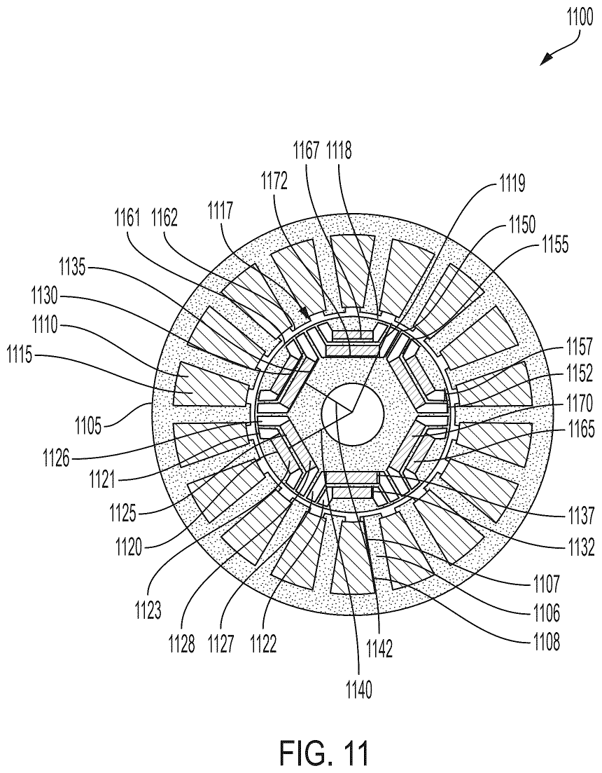

FIG. 11 illustrates a permanent magnet-assisted synchronous reluctance motor 1100, according to some embodiments. The motor 1100 includes a stator 1105 and a plurality of stator winding slots 1110. The stator 1105 includes a plurality of stator teeth 1106. The plurality of stator teeth including a stator tooth width 1107 and a stator tooth length 1108. The plurality of stator winding slots 1110 are configured to receive a plurality of windings 1115. The motor 1100 includes a rotor 1117. The rotor 1117 includes a circumferential outside surface 1118 of rotor 1117 spaced a first radial distance 1119 away from the center of rotation of the rotor 1017.

The rotor 1117 includes first slot 1120 and second slot 1125. The first slot 1120) includes a first arm 1121 and a second arm 1122, and a first magnet housing portion 1123 is positioned therebetween. The second slot 1125 includes a first arm 1126 and a second arm 1127, and a second magnet housing portion 1128 is positioned therebetween. The first arm 1121 and the second arm 1122 of the first slot 1120 have a first length 1155 and a first width 1157. In some embodiments, the first length 1155 is between 2 times the airgap thickness and 50% of the first radial distance 1119, and the first width 1157 is between 2.5% and 200% of the first magnet housing portion length 1130. The airgap thickness is the distance between a rotor outer diameter 1161 and a stator inner diameter 1162. The first arm 1126 and the second arm 1127 of the second slot 1125 have a first length 1150 and a first width 1152. In some embodiments, the first length 1150 is between 2 times an airgap thickness and 50% of the first radial distance 1119, and the first width 1152 is between 2.5% and 200% of the second magnet housing portion length 1135

The first magnet housing portion 1123 has a first magnet housing portion length 1130 and a first magnet housing portion width 1132. In some embodiments, the first magnet housing portion length 1130 is larger than the stator tooth width 1107, and the first magnet housing portion width 1132 is between 0.5 to 10 times the airgap thickness. In some embodiments, the first magnet housing portion 1123 has a corresponding magnet fill or magnet fill percentage. The second magnet housing portion 1128 has a second magnet housing portion length 1135 and a second magnet housing portion width 1137. In some embodiments, the second magnet housing portion length 1135 is larger than the stator tooth width 1107, and the second magnet housing portion width 1137 is between 0.5 to 10 times the airgap thickness. In some embodiments, the second magnet housing portion 1128 has a corresponding magnet fill or magnet fill percentage.

In some embodiments, the first slot 1120 is referred to as an outer slot, and the second slot 1125 is referred to as an inner slot. In some embodiments, the first slot 1120 and the second slot 1125 are positioned at different radial distances from the center of rotation of rotor 1117. The first magnet housing portion 1123 is positioned a second radial distance 1140 away from the center of rotation of the rotor, the second radial distance 1140 being less than the first radial distance 1119. In some embodiments, the first radial distance 1119 is no more than 90% of a radius of the stator outer diameter, and the second radial distance 1140 is between 50% and 90% of the first radial distance 1119. The second magnet housing portion 1128 is positioned a third radial distance 1142 away from the center of rotation of the rotor, the third radial distance 1142 being less than the first radial distance 1119 and the second radial distance 1140.

The first magnet housing portion 1123 is configured to receive a magnet, such as magnet 1165. The magnet 1165 has a length 1167. In some embodiments, a magnet, such as magnet 1165, fills between 80% and 100% of the first magnet housing portion 1123 (e.g., 90% of the first magnet housing portion length 1130). In some embodiments, magnet 1165 has a length 1167 that is less than the total length of the first magnet housing portion length 1130. The second magnet housing portion 1128 is configured to receive a magnet, such as magnet 1170. The magnet 1170 has a length 1172. In some embodiments, a magnet, such as magnet 1170, fills between 80% and 100% of the second magnet housing portion 1128 (e.g., 90% of the second magnet housing portion length 1135). In some embodiments, magnet 1170 has a length 1172 that is less than the total length of the second magnet housing portion length 1135. In some embodiments, the magnets 1165 and 1170 are rare earth magnets (e.g., neodymium magnets). In some embodiments, rotor 1117 includes at least six rotor poles.

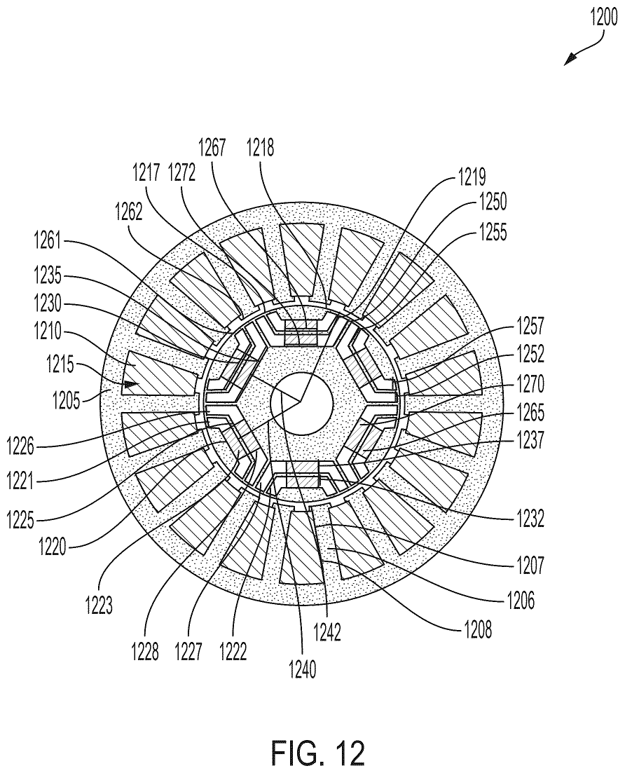

FIG. 12 illustrates a permanent magnet-assisted synchronous reluctance motor 1200, according to some embodiments. The motor 1200 includes a stator 1205 and a plurality of stator winding slots 1210. The stator 1205 includes a plurality of stator teeth 1206. The plurality of stator teeth include a stator tooth width 1207 and a stator tooth length 1208. The plurality of stator winding slots 1210 are configured to receive a plurality of windings 1215. The motor 1200 includes a rotor 1217. The rotor 1217 includes a circumferential outside surface 1218 of rotor 1217 spaced a first radial distance 1219 away from the center of rotation of the rotor 1217.

The rotor 1217 includes a first slot 1220 and a second slot 1225. The first slot 1220 includes a first arm 1221 and a second arm 1222, and a first magnet housing portion 1223 is positioned therebetween. The second slot 1225 includes a first arm 1226 and a second arm 1227, and a second magnet housing portion 1228 is positioned therebetween. The first arm 1221 and the second arm 1222 of the first slot 1220 have a first length 1255 and a first width 1257. In some embodiments, the first length 1255 is between 2 times the airgap thickness and 50% of the first radial distance 1219, and the first width 1257 is between 2.5% and 200% of the first magnet housing portion length 1230. The airgap thickness is the distance between a rotor outer diameter 1261 and a stator inner diameter 1262. The first arm 1226 and the second arm 1227 of the second slot 1225 have a first length 1250 and a first width 1252. In some embodiments, the first length 1250 is between 2 times the airgap thickness and 50% of the first radial distance 1219, and the first width 1152 is between 2.5% and 200% of the second magnet housing portion length 1235.

The first magnet housing portion 1223 has a first magnet housing portion length 1230 and a first magnet housing portion width 1232. In some embodiments, the first magnet housing portion length 1230 is larger than the stator tooth width 1207, and the first magnet housing portion width 1232 is between 0.5 to 10 times the airgap thickness. In some embodiments, the first magnet housing portion 1223 has a corresponding magnet fill or magnet fill percentage.

The second magnet housing portion 1228 has a second magnet housing portion length 1235 and a second magnet housing portion width 1237. In some embodiments, the second magnet housing portion length 1235 is larger than the stator tooth width 1207, and the second magnet housing portion width 1237 is between 0.5 to 10 times the airgap thickness. In some embodiments, the second magnet housing portion 1228 has a corresponding magnet fill or magnet fill percentage.

In some embodiments, the first slot 1220 is referred to as an outer slot, and the second slot 1225 is referred to as an inner slot. In some embodiments, the first slot 1220) and the second slot 1225 are positioned at different radial distances from the center of rotation of rotor 1217. The first magnet housing portion 1223 is positioned a second radial distance 1240 away from the center of rotation of the rotor 1217, the second radial distance 1240) being less than the first radial distance 1219. In some embodiments, the first radial distance 1219 is no more than 90% of a radius of the stator outer diameter, and the second radial distance 1240) is between 50% and 95% of the first radial distance 1219. The second magnet housing portion 1228 is positioned a third radial distance 1242 away from the center of rotation of the rotor 1217, the third radial distance 1242 being less than the first radial distance 1219 and the second radial distance 1240.

The first magnet housing portion 1223 is configured to receive a magnet, such as magnet 1265. The magnet 1265 has a length 1267. In some embodiments, a magnet, such as magnet 1265, fills between 30% and 90% of the first magnet housing portion 1223 (e.g., 30% to 90% of the first magnet housing portion length 1230). In some embodiments, magnet 1265 has a length 1267 that is less than the total length of the first magnet housing portion length 1230.

The second magnet housing portion 1228 is configured to receive a magnet, such as magnet 1270. The magnet 1270 has a length 1272. In some embodiments, a magnet, such as magnet 1270, fills between 30% and 90% of the second magnet housing portion 1228 (e.g., 30% to 90% of the second magnet housing portion length 1235). In some embodiments, magnet 1270 has a length 1272 that is less than the total length of the second magnet housing portion length 1235. In some embodiments, the magnets 1265 and 1270 are rare earth magnets (e.g., neodymium magnets). In some embodiments, rotor 1217 includes at least six rotor poles.

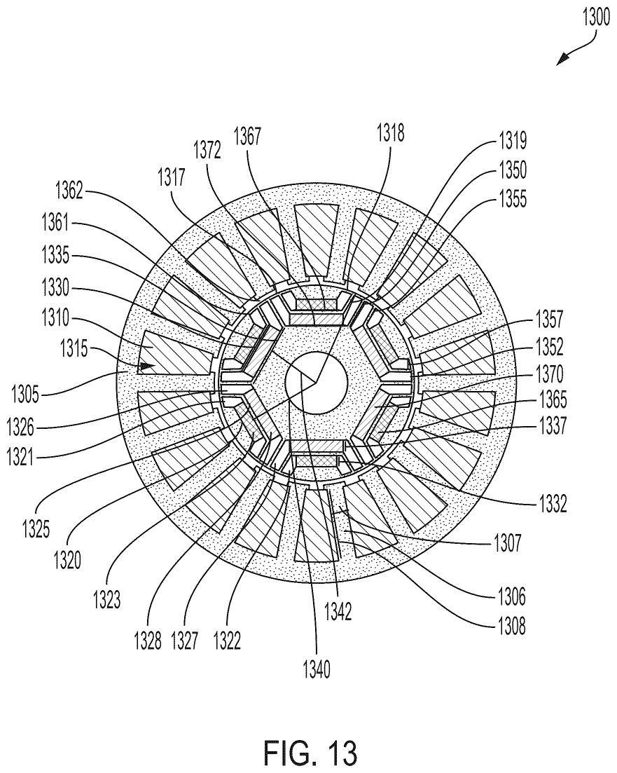

FIG. 13 illustrates a permanent magnet-assisted synchronous reluctance motor 1300, according to some embodiments. The motor 1300 includes a stator 1305 and a plurality of stator winding slots 1310. The stator 1305 includes a plurality of stator teeth 1306. The plurality of stator teeth include a stator tooth width 1307 and a stator tooth length 1308. The plurality of stator winding slots 1310 are configured to receive a plurality of windings 1315. The motor 1300 includes a rotor 1317. The rotor 1317 includes a circumferential outside surface 1318 of rotor 1317 spaced a first radial distance 1319 away from the center of rotation of the rotor 1317.

The rotor 1317 includes a first slot 1320 and a second slot 1325. The first slot 1320 includes a first arm 1321 and a second arm 1322, and a first magnet housing portion 1323 is positioned therebetween. The second slot 1325 includes a first arm 1326 and a second arm 1327, and a second magnet housing portion 1328 is positioned therebetween. The first arm 1321 and the second arm 1322 of the first slot 1320 have a first length 1355 and a first width 1357. In some embodiments, the first length 1355 is between 2 times the airgap thickness and 50% of the first radial distance 1319, and the first width 1357 is between 2.5% and 200% of the first magnet housing portion length 1330. The airgap thickness is the distance between a rotor outer diameter 1361 and a stator inner diameter 1362. The first arm 1326 and the second arm 1327 of the second slot 1325 have a first length 1350 and a first width 1352. In some embodiments, the first length 1350 is between 2 times the airgap thickness and 50% of the first radial distance 1319, and the first width 1352 is between 2.5% and 200% of the second magnet housing portion length 1335.

The first magnet housing portion 1323 has a first magnet housing portion length 1130 and a first magnet housing portion width 1332. In some embodiments, the first magnet housing portion length 1330 is larger than the stator tooth width 1307, and the first magnet housing portion width 1332 is between 0.5 to 10 times the airgap thickness. In some embodiments, the first magnet housing portion 1323 has a corresponding magnet fill or magnet fill percentage.

The second magnet housing portion 1328 has a second magnet housing portion length 1335 and a second magnet housing portion width 1337. In some embodiments, the second magnet housing portion length 1335 is larger than the stator tooth width 1307, and the second magnet housing portion width 1337 is 0.5 to 10 times the airgap thickness. In some embodiments, the second magnet housing portion 1328 has a corresponding magnet fill or magnet fill percentage.

The first magnet housing portion 1323 is positioned a second radial distance 1340 away from the center of rotation of the rotor 1317, the second radial distance 1340 being less than the first radial distance 1319. The second magnet housing portion 1328 is positioned a third radial distance 1342 away from the center of rotation of the rotor 1317, the third radial distance 1342 being less than the first radial distance 1319 and the second radial distance 1340. In some embodiments, the first radial distance 1319 is no more than 90% of a radius of the stator outer diameter, the second radial distance 1340 is between 50% and 95% of the first radial distance 1319, and the third radial distance 1342 is between 50% and 95% of the first radial distance 1319.

The first magnet housing portion 1323 is configured to receive a magnet, such as magnet 1365. The magnet 1365 has a length 1367. In some embodiments, a magnet, such as magnet 1365, fills between 30% and 100% of the first magnet housing portion 1323 (e.g., between 30 and 100% of the first magnet housing portion length 1330). In some embodiments, magnet 1365 has a length 1367 that is less than the total length of the first magnet housing portion length 1330. In some embodiments, magnet 1365 is made of rare earth metal materials, such as neodymium.

In some embodiments, the first slot 1320 is referred to as an outer slot, and the second slot 1325 is referred to as an inner slot. In some embodiments, the first slot 1320) and the second slot 1325 are positioned at different radial distances from the center of rotation of rotor 1317. The second magnet housing portion 1328 is configured to receive a magnet, such as magnet 1370. The magnet 1370 has a length 1372. In some embodiments, a magnet, such as magnet 1370, fills between 30% and 100% of the second magnet housing portion 1328 (e.g., between 30% and 100% of the second magnet housing portion length 1335). In some embodiments, magnet 1370) has a length 1372 that is less than the total length of the second magnet housing portion length 1135. In some embodiments, magnet 1370 is made of a different material than magnet 1365, such as a ferrite material. In some embodiments, rotor 1317 includes at least six rotor poles.

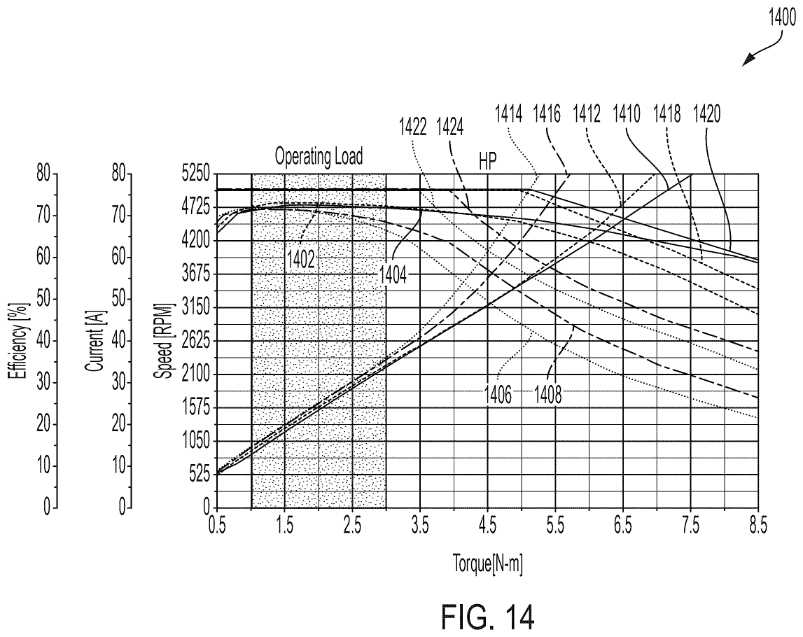

FIG. 14 is a graphical representation of efficiency, electrical current, and speed in revolutions per minute (“RPM”) compared to torque outputs of several different motors in the power tool 100, in accordance with some embodiments. In some embodiments, the motor represented in graph 1400 is the motor of a plate compactor. The graph 1400 includes a representation of the efficiency of several different motors within the power tool 100. A curve 1402 illustrates an efficiency of one type of motor of the power tool 100, such as motor 1000. A curve 1404 illustrates an efficiency of a second type of motor of the power tool 100, such as motor 1100. A curve 1406 illustrates an efficiency of a third type of motor of the power tool 100, such as the motor 1200. A curve 1408 illustrates an efficiency of a fourth type of motor of the power tool 100, such as the motor 1300. In some embodiments, the curve 1402 is the efficiency of motor 1000 as torque values increase. In some embodiments. the curve 1404 is the efficiency of motor 1100 as torque values increase. In some embodiments, the efficiency of motor 1100 is approximately equal to motor 1000 below 5.0 Nm. In some embodiments, the curve 1406 is the efficiency of motor 1200 as torque values increase. In some embodiments, the efficiency of motor 1200 diminishes at a faster rate than motor 1100 and motor 1000 for a given torque value. In some embodiments, the curve 1408 is the efficiency of motor 1300 as torque values increase. In some embodiments, the efficiency of motor 1300 diminishes at a faster rate than motors 1000 and 1100.

The graph 1400 additionally includes a representation of the electrical current of several different motors within the power tool 100. A curve 1410 illustrates an electrical current of one type of motor of the power tool 100, such as the motor 1000. A curve 1412 illustrates an electrical current of a second type of motor of the power tool 100, such as the motor 1100. A curve 1414 illustrates an electrical current of a third type of motor of the power tool 100, such as motor 1200. A curve 1416 illustrates an electrical current of a fourth type of motor of the power tool 100, such as the motor 1300. In some embodiments, the curve 1410 is the electrical current level of motor 1000 as torque values increase. In some embodiments, the curve 1412 is the electrical current of motor 1100 as torque values increase. In some embodiments, as torque increases, the electrical current of both motor 1000 and motor 1100 is approximately equal below 3.0 Nm. In some embodiments, the curve 1414 is the electrical current of motor 1200 as torque values increase. In some embodiments, as torque increases, the electrical current of motor 1200 is greater than both motor 1000 and 1100 for a given torque value. In some embodiments, the curve 1416 is the electrical current of motor 1300 as torque values increase. In some embodiments, as torque increases, the electrical current of motor 1300 is greater than motors 1000, 1100, and 1200 for a given torque value.

Graph 1400 additionally includes a representation of the RPM of several different motors within the power tool 100. A curve 1418 illustrates an RPM of one type of motor of the power tool 100, such as the motor 1000. A curve 1420 illustrates an RPM of a second type of motor of the power tool 100, such as the motor 1100. A curve 1422 illustrates an RPM of a third type of motor of the power tool 100, such as the motor 1200. A curve 1424 illustrates an RPM of a fourth type of motor of the power tool 100, such as the motor 1300. In some embodiments, the curve 1418 is the RPM level of motor 1000 as torque values increase. In some embodiments, the curve 1420 is the RPM of motor 1100 as torque values increase. In some embodiments, as torque increases, the RPM of motor 1100 is approximately equal to the RPM of motor 1000 below approximately 5 Nm. In some embodiments, as the torque increases, the RPM of motor 1100 diminishes at a faster rate than the RPM of motor 1000 after approximately 5 Nm. In some embodiments, the curve 1422 is the RPM of motor 1200 as torque values increase. In some embodiments, as torque increases, the RPM of motor 1200 is approximately equal to motor 1000 and motor 1100 before approximately 3.5 Nm. In some embodiments, as torque increases, the RPM of motor 1200 diminishes at a faster rate than the RPM of motor 1000 and motor 1100 after approximately 3.5 Nm. In some embodiments, curve the 1424 is the RPM of the motor 1300 as torque values increase. In some embodiments, as torque increases, the RPM of motor 1300 the RPM of motor 1300 is equal to the RPM of motors 1000, 1100 below 4 Nm. In some embodiments, as torque increases, the RPM of motor 1300 diminishes faster than the RPM of motors 1000, 1100 after 4 Nm. In some embodiments, for the operating load of the power tool 100, each motor operates at approximately the same speed.

In some embodiments, each of the motors 1000, 1100, 1200, and 1300 have stator diameters of 100 millimeters and are operated from a battery pack having a maximum voltage of approximately 83.5 V. In some embodiments, the stator slot fill for each stator winding is approximately 43% and a phase winding resistant is between 0.11 Ohms and 0.25 Ohms. Table 3 below provides relative performance data for the various motors. As illustrated below, only small reductions in run time and efficiency were observed compared to significant reductions in the amount of rare earth magnets (e.g., neodymium) used in the motors. For example, the motor 1100 operated for the same amount of time (e.g., until battery pack was fully discharged), with the same efficiency, and with a 6% reduction in rare earth magnet mass. The motor 1200 operated for 3% less time (e.g., until battery pack was fully discharged), with 1% reduced efficiency, and with a 35% reduction in rare earth magnet mass. The motor 1300 operated for 3% less time (e.g., until battery pack was fully discharged), with 2% reduced efficiency, and with a 46% reduction in rare earth magnet mass.

TABLE 3
Motor Performance With Reduced Rare Earth Magnet Fill

| | Motor 1000 | Motor 1100 | Motor 1200 | Motor 1300 |
|---|---|---|---|---|
| Run Time | 100% | 100% | 97% | 97% |
| Efficiency | 72% | 72% | 71% | 70% |
| Magnet Mass | 100% | 94% | 65% | 54% |

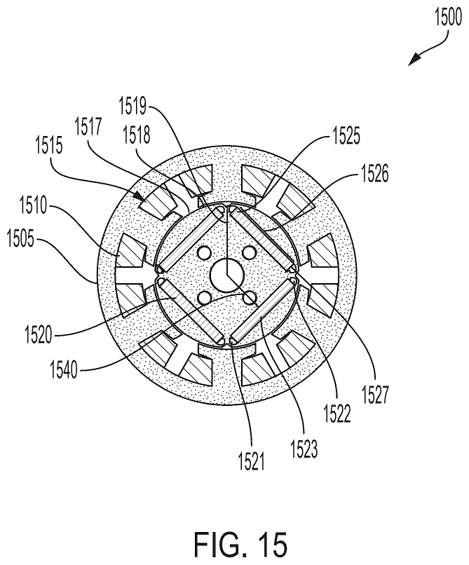

FIG. 15 illustrates an internal permanent magnet motor 1500, according to some embodiments. The motor 1500 includes a stator 1505 and a plurality of stator winding slots 1510. The plurality of stator winding slots 1510 are configured to receive a plurality of windings 1515. The motor 1500 includes a rotor 1517. The rotor 1517 includes a circumferential outside surface 1518 spaced a first radial distance 1519 away from the center of rotation of the rotor 1517. The rotor 1517 includes a plurality of slots 1520 configured to receive magnets. In some embodiments, slots 1520 include a first arm 1521 and a second arm 1522, and a magnet housing portion 1523 of the slot positioned therebetween. Magnet housing portion 1523 is configured to be spaced a second radial distance 1540 away from the center of rotation of rotor 1517. Magnet housing portion 1523 is configured to receive a magnet 1525 with a length 1526 and a width 1527. In some embodiments, the magnet 1525 has a length 1526 that fills approximately 100% of the magnet housing portion 1523.

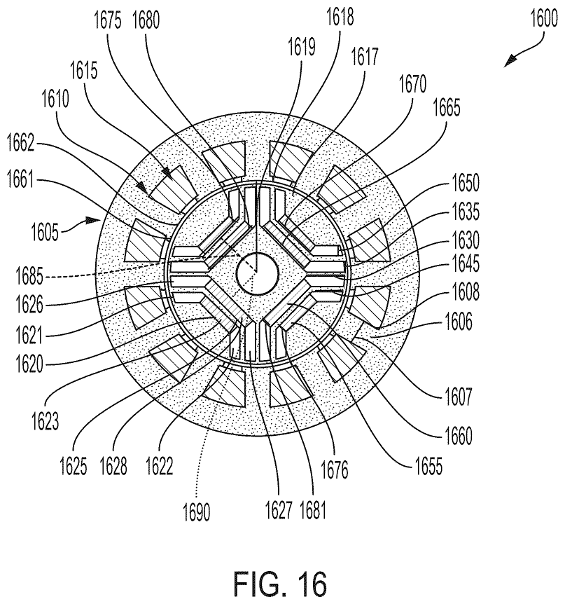

FIG. 16 illustrates a permanent magnet-assisted synchronous reluctance motor 1600, according to some embodiments. The motor 1600 includes a stator 1605 and a plurality of stator winding slots 1610. In some embodiments, stator 1605 is configured to include at least twelve stator slots. The stator 1605 includes a plurality of stator teeth 1606. The plurality of stator teeth including a stator tooth width 1607 and a stator tooth length 1608. The plurality of stator winding slots 1610 are configured to receive a plurality of windings 1615. The motor 1600 includes a rotor 1617. The rotor 1617 includes a circumferential outside surface 1618 spaced a first radial distance 1619 away from the center of rotation of the rotor 1617. In some embodiments, the first radial distance 1619 is no more than 90% of a radius of the stator outer diameter.

Rotor 1617 includes a first slot 1620 and a second slot 1625. The first slot 1620 includes a first arm 1621 and a second arm 1622, and a first magnet housing portion 1623 is positioned therebetween. The second slot 1625 includes a first arm 1626 and a second arm 1627, and a second magnet housing portion 1628 is positioned therebetween.

The first arm 1621 and the second arm 1622 of the first slot 1620 have a first length 1645 and a first width 1650. In some embodiments, the first length 1645 is between 2 times the airgap thickness and 50% of the first radial distance 1619, and the first width 1650 is between 2.5% and 200% of the first magnet housing portion length 1675. The airgap thickness is the distance between a rotor outer diameter 1661 and a stator inner diameter 1362. The first magnet housing portion 1623 has a first magnet housing portion length 1675 and a first magnet housing portion width 1676. In some embodiments, the first magnet housing portion length 1675 is larger than the stator tooth width 1607, and the first magnet housing portion width 1676 is between 0.5 to 10 times the airgap thickness. In some embodiments, the first magnet housing portion 1623 has a corresponding magnet fill or magnet fill percentage.

The first arm 1626 and the second arm 1627 of the second slot 1625 have a first length 1630 and a first width 1635. In some embodiments, the first length 1630 is between 2 times the airgap thickness and 50% of the first radial distance 1619, and the first width 1635 is between 0.5 to 10 times the airgap thickness. The second magnet housing portion 1628 has a second magnet housing portion length 1680 and a second magnet housing portion width 1681. In some embodiments, the second magnet housing portion length 1680 is larger than the stator tooth width 1607, and the second magnet housing portion width 1681 is between 2.5% and 200% of the length 1665 of the magnet 1660. In some embodiments, the second magnet housing portion 1628 has a corresponding magnet fill or magnet fill percentage.

The first magnet housing portion 1623 is configured to receive a magnet, such as magnet 1655. In some embodiments, a magnet, such as magnet 1655, fills between 30% and 100% of the first magnet housing portion 1623 (e.g., 30% to 100% of the first magnet housing portion length 1675). In some embodiments, the magnet 1655 has a length 1670 that is less than the total length of the first magnet housing portion length 1675.

The second magnet housing portion 1628 is configured to receive a magnet, such as magnet 1660. In some embodiments, similar to the first magnet housing portion, the second magnet housing portion 1628 is configured to receive a magnet that fills between 30% and 100% of the second magnet housing portion 1628 (e.g., 30% to 100% of the second magnet housing portion length 1680). In some embodiments, the magnet 1660 has a length 1665 that is less than the length of the first magnet housing portion length 1675. In some embodiments, magnet 1660 fills at least as much of the second magnet housing portion 1628 as magnet 1655 fills the first magnet housing portion 1623. For example, the magnet 1655 corresponds to a greater fill percentage of the first magnet housing portion 1623 than the magnet 1660 does of the second magnet housing portion 1628. In some embodiments, the magnet 1660 fills between 30% and 100% of the second magnet housing portion 1628. In some embodiments, the magnets 1655 and 1660 are rare earth magnets (e.g., neodymium magnets).

In some embodiments, the first slot 1620 is referred to as an outer slot, and the second slot 1625 is referred to as an inner slot. In some embodiments, the first slot 1620 and the second slot 1625 are positioned at different radial distances from the center of rotation of rotor 1617. For example, the first slot 1620 is positioned at a second radial distance 1685 from the center of rotation of the rotor 1617. In some embodiments, the second radial distance 1685 is between is 50% to 95% of the first radial distance 1619, and the second slot 1625 is positioned a third radial distance 1690 from the center of rotation of the rotor 1617. In some embodiments, and the third radial distance 1690 is between 50% and 95% of the first radial distance 1619. In some embodiments, the first radial distance 1619 is greater than the second radial distance 1685. In some embodiments, rotor 1617 includes at least four rotor poles.

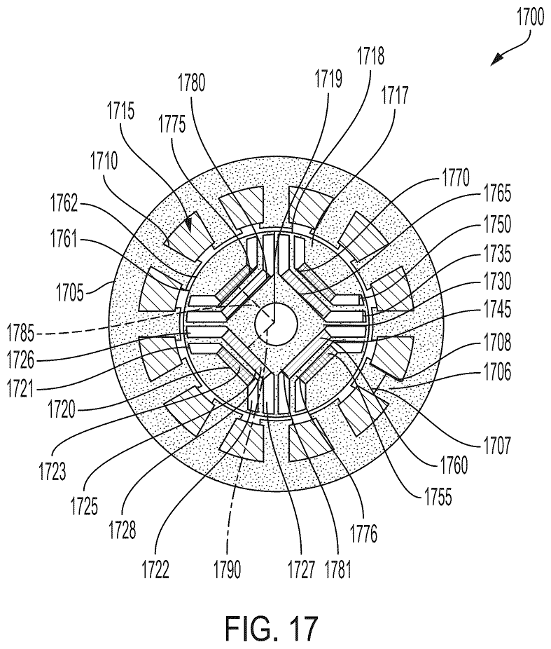

FIG. 17 illustrates a permanent magnet-assisted synchronous reluctance motor 1700 including magnets made of two different materials, according to some embodiments. The motor 1700 includes a stator 1705 and a plurality of stator winding slots 1710. The stator 1705 includes a plurality of stator teeth 1706. The plurality of stator teeth including a stator tooth width 1707 and a stator tooth length 1708. In some embodiments, stator 1705 is configured to include at least twelve stator slots. The plurality of stator winding slots 1710 are configured to receive a plurality of windings 1715. The motor 1700 includes a rotor 1717. The rotor 1717 includes a circumferential outside surface 1718 spaced a first radial distance 1719 away from the center of rotation of the rotor 1717. In some embodiments, the first radial distance 1719 is no more than 90% of a radius of the stator outer diameter.

The rotor 1717 includes a first slot 1720 and a second slot 1725. The first slot 1720 includes a first arm 1721 and a second arm 1722, and a first magnet housing portion 1723 is positioned therebetween. The second slot 1725 includes a first arm 1726 and a second arm 1727, and a second magnet housing portion 1728 is positioned therebetween.

The first arm 1721 and the second arm 1722 of the first slot 1720 have a first length 1745 and a first width 1750. In some embodiments, the first length 1745 is between 2 times the airgap thickness and 50% of the first radial distance 1719, and the first width 1750) is between 2.5% and 200% of the first magnet housing portion length 1775. The airgap thickness is the distance between a rotor outer diameter 1761 and a stator inner diameter 1762. The first magnet housing portion 1723 has a first magnet housing portion length 1775 and a first magnet housing portion width 1776. In some embodiments, the first magnet housing portion length 1775 is larger than the stator tooth width 1707, and the first magnet housing portion width 1776 is 0.5 to 10 times the airgap thickness. In some embodiments, the first magnet housing portion 1723 has a corresponding magnet fill or magnet fill percentage.

The first arm 1726 and the second arm 1727 of the second slot 1725 have a first length 1730 and a first width 1735. In some embodiments, the first length 1730 is between 2 times the airgap thickness and 50% of the first radial distance 1719, and the first width 1735 is between 2.5% and 200% of the second magnet housing portion length 1780. The second magnet housing portion 1728 has a second magnet housing portion length 1780 and a second magnet housing portion width 1781. In some embodiments, the second magnet housing portion length 1780 is larger than the stator tooth width 1707, and the second magnet housing portion width 1781 is 0.5 to 10 times the airgap thickness. In some embodiments, the second magnet housing portion 1728 has a corresponding magnet fill or magnet fill percentage.

The first magnet housing portion 1723 is configured to receive a magnet, such as magnet 1755. In some embodiments, a magnet, such as magnet 1755, fills the first magnet housing portion 1723 between 30% and 100% of the first magnet housing portion (e.g., 30% to 100% of the first magnet housing portion length 1775). In some embodiments, the magnet 1755 has a length 1770 that is less than the total length of the first magnet housing portion length 1775.

The second magnet housing portion 1728 is configured to receive a magnet, such as magnet 1760. In some embodiments, similar to the first magnet housing portion, the second magnet housing portion 1728 is configured to receive a magnet that fills the second magnet housing portion 1728 between 30% and 100% of the second magnet housing portion 1728 (e.g., 30 to 100% of the second magnet housing portion length 1780). In some embodiments, magnet 1760 has a length 1765 that is less than the length of the first magnet housing portion length 1775. In some embodiments, magnet 1760 fills at least as much of the second magnet housing portion 1728 as magnet 1755 fills the first magnet housing portion 1723. For example, the magnet 1755 corresponds to a greater fill percentage of the first magnet housing portion 1673 than the magnet 1760 does of the second magnet housing portion 1728. In some embodiments, the magnet 1760 fills between 30% and 90% of the second magnet housing portion 1678. In some embodiments, the magnets 1755 and 1760 are rare earth magnets (e.g., neodymium magnets).

In some embodiments, the first slot 1720 is referred to as an outer slot, and the second slot 1725 is referred to as an inner slot. In some embodiments, the first slot 1720 and the second slot 1725 are positioned at different radial distances from the center of rotation of rotor 1717. For example, the first slot 1720 is positioned at a second radial distance 1785 from the center of rotation of the rotor 1717. In some embodiments, the second radial distance 1785 is no more than 50 to 95% of the first radial distance 1719, and the second slot 1725 is positioned a third radial distance 1790 from the center of rotation of the rotor 1717. In some embodiments, the third radial distance 1790 is between 50% and 95% of the first radial distance 1719. In some embodiments, the second radial distance 1785 is greater than the third radial distance 1790. In some embodiments, rotor 1717 includes at least four rotor poles.

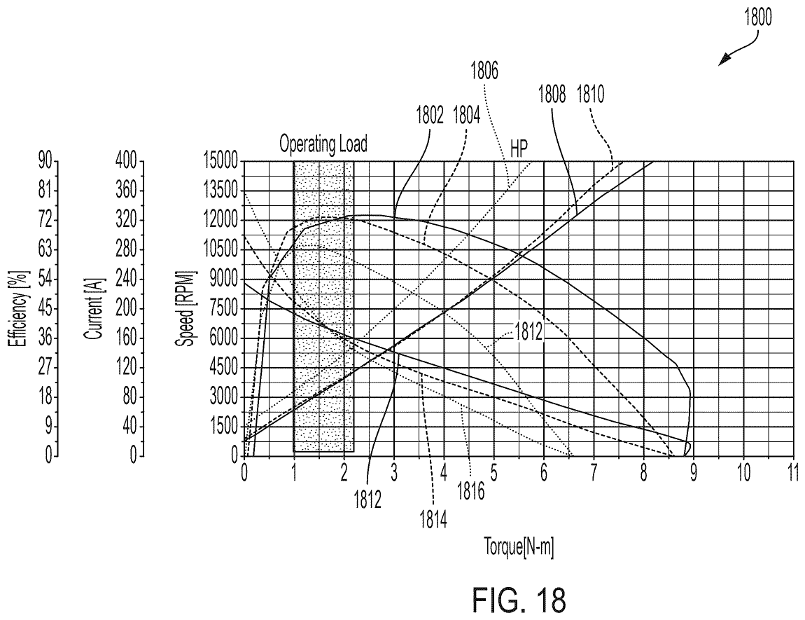

FIG. 18 is a graphical representation of efficiency, electrical current, and speed in revolutions per minute (“RPM”) compared to torque outputs of several different internal permanent magnet motors in the power tool 100, in accordance with some embodiments. In some embodiments, the motor represented in the graph 1800 is the motor of a small angle grinder. The graph 1800 includes a representation of the efficiency of several different motors within the power tool 100. A curve 1802 illustrates an efficiency of one type of motor of the power tool 100, such as motor 1500. A curve 1804 illustrates an efficiency of a second type of motor of the power tool 100, such as motor 1600. A curve 1806 illustrates an efficiency of a third type of motor of the power tool 100, such as motor 1700. In some embodiments, the curve 1802 is the efficiency of motor 1500 as torque values increase. In some embodiments, the curve 1804 is the efficiency of motor 1600 as torque values increase. In some embodiments, as torque increases, the efficiency of motor 1600 is diminishes at a fast rate than the efficiency of motor 1500 for a given torque value. In some embodiments, the curve 1806 is the efficiency of motor 1700 as torque values increase. In some embodiments, the efficiency of motor 1700 diminishes at a faster rate than motor 1600 and motor 1500 for a given torque value.

The graph 1800 additionally includes a representation of the electrical current of several different motors within the power tool 100. A curve 1808 illustrates an electrical current of one type of motor of the power tool 100, such as motor 1500. A curve 1810 illustrates an electrical current of a second type of motor of the power tool 100, such as motor 1600. A curve 1812 illustrates an electrical current of a third type of motor of the power tool 100, such as motor 1700. In some embodiments, the curve 1808 is the electrical current level of motor 1500 as torque values increase. In some embodiments, the curve 1810 is the electrical current of motor 1600 as torque values increase. In some embodiments, as torque increases, the electrical current of both motor 1500 and motor 1600 are approximately equal below 4.5 Nm. In some embodiments, the curve 1812 is the electrical current of motor 1700 as torque values increase. In some embodiments, as torque increases, the electrical current of motor 1700 is greater than both motor 1500 and 1600 for a given torque value.

The graph 1800 additionally includes a representation of the RPM of several different motors within the power tool 100. A curve 1812 illustrates an RPM of one type of motor of the power tool, such as motor 1500. A curve 1814 illustrates an RPM of a second type of motor of the power tool 100, such as motor 1600. A curve 1816 illustrates an RPM of a third type of motor of the power tool 100, such as motor 1700. In some embodiments, the curve 1812 is the RPM level of motor 1500 as torque values increase. In some embodiments, the curve 1814 is the RPM of motor 1600 as torque values increase. In some embodiments, as the torque increases, the RPM of motor 1600 starts higher and then diminishes at a faster rate than the RPM of motor 1500 for a given torque value. In some embodiments, the curve 1816 is the RPM of motor 1700 as torque values increase. In some embodiments, as torque increases, the RPM of motor 1700 starts higher and then diminishes at a faster rate than the RPM of motor 1500 and motor 1600 for a given torque value.

In some embodiments, each of the motors 1500, 1600, and 1700 have stator diameters of 60 millimeters and are operated from a battery pack having a maximum voltage of approximately 20.4 V. In some embodiments, the stator slot fill for each stator winding is approximately 45% and a phase winding resistant is between 6 milliohms and 11 milliohms. Table 4 below provides relative performance data for the various motors. As illustrated below, only small reductions in run time and efficiency were observed compared to significant reductions in the amount of rare earth magnets (e.g., neodymium) used in the motors. For example, the motor 1600 operated for the same amount of time (e.g., until battery pack was fully discharged), at the same speed, with 1% increased efficiency, and with a 22 reduction in rare earth magnet mass. The motor 1700 operated for 19% less time (e.g., until battery pack was fully discharged), at the same speed, with 5% reduced efficiency, and with a 70% reduction in rare earth magnet mass.

TABLE 4
Motor Performance With Reduced Rare Earth Magnet Fill

| | Motor 1500 | Motor 1600 | Motor 1700 |
|---|---|---|---|
| Run Time | 100% | 100% | 81% |
| Application Speed | 6700 RPM | 6700 RPM | 6700 RPM |
| Efficiency | 70% | 71% | 65% |
| Magnet Mass | 100% | 78% | 30% |

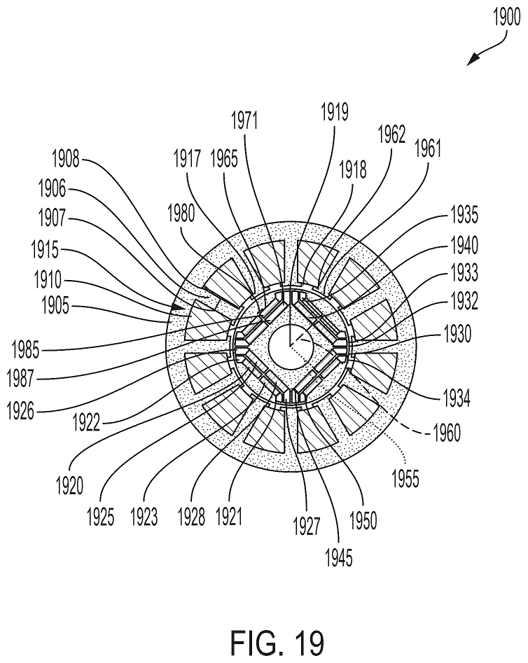

FIG. 19 illustrates a permanent magnet-assisted synchronous reluctance motor 1900 including ribs, according to some embodiments. The motor 1900 includes a stator 1905 and a plurality of stator winding slots 1910. The stator 1905 includes a plurality of stator teeth 1906. The plurality of stator teeth including a stator tooth width 1907 and a stator tooth length 1908. The plurality of stator winding slots 1910 are configured to receive a plurality of windings 1915. The motor 1900 includes a rotor 1917. The rotor 1917 includes a first slot 1920 and a second slot 1925. The first slot 1920 includes a first arm 1921 and a second arm 1922, and a first magnet housing portion 1923 is positioned therebetween. The second slot 1925 includes a first arm 1926 and a second arm 1927, and a second magnet housing portion 1928 is positioned therebetween. The rotor 1917 includes a circumferential outside surface 1918 of rotor 1917, spaced a first radial distance 1919 away from the center of rotation of the rotor 1917. In some embodiments, the first radial distance 1919 is no more than 90% of a radius of the stator outer diameter. The first arm 1921 and the second arm 1922 of the first slot 1920 includes a first width 1934 and a first length 1930. In some embodiments, the first width 1934 is between 2% and 50% of the first length 1935 of the first magnet housing portion 1923, and the first length 1930 is between 2 times the airgap thickness and 50% of the first radial distance 1919. The airgap thickness is the distance between a rotor outer diameter 1961 and a stator inner diameter 1962. The first arm 1926 the second arm 1927 of the second slot 1925 includes a first width 1933 and a first length 1932. In some embodiments, the first width 1933 is between 2.5% and 200% of the first length 1940 of the second magnet housing portion 1928, and the first length 1932 is between 2 times the airgap thickness and 50% of the first radial distance 1919.

The first magnet housing portion 1923 includes a first width 1950 and a first length 1935. In some embodiments, the first width 1950 is between 0.5 to 10 times the airgap thickness, and the first length 1935 is larger than 50% of the width of the stator tooth width 1907. The first magnet housing portion 1923 includes a first steel rib 1985 positioned at the center of the first magnet housing portion 1923 and equidistant from the first arm 1921 and the second arm 1922 of the first slot 1920. In some embodiments, the first steel rib 1985 is configured to have a length 1980 and fill a portion of the first magnet housing portion 1923 equal to the length 1980 of the first steel rib 1985.

The second magnet housing portion 1928 includes a first width 1945 and a first length 1940. In some embodiments, the first width 1945 is between 0.5 to 10 times the airgap thickness, and the first length 1940 is larger than 50% of the width of the stator tooth width 1907. The second magnet housing portion 1928 includes a second steel rib 1987 positioned at the center of the second magnet housing portion 1928 and equidistant from the first arm 1926 and the second arm 1927 of the second slot 1925. In some embodiments, the second steel rib 1987 is configured to have a length 1980 that is the same as the length of the first steel rib 1985 and fill a portion of the second magnet housing portion 1928 equal to the length 1980 of the second steel rib 1987.

In some embodiments, the first slot 1920 is referred to as an outer slot, and the second slot 1925 is referred to as an inner slot. In some embodiments, the first slot and the second slot are positioned at different radial distances from the center of rotation of rotor 1917. For example, a first slot 1920 is positioned at a second radial distance 1955 from the center of rotation, the second radial distance being no more than 50% to 95% of the first radial distance 1919, and a second slot 1925 is positioned a third radial distance 1960 from the center of rotation, the third radial distance being between 50% and 95% of the first radial distance 1919, and where the second radial distance 1955 is greater than the third radial distance 1960.

First magnet housing portion 1923 is configured to receive a magnet, such as magnet 1965. In some embodiments, magnet 1965 is configured to fill approximately 100% of the first magnet housing portion 1923 that is not filled by the first steel rib 1985. Second magnet housing portion 1928 is configured to receive a magnet, such as magnet 1970. In some embodiments, magnet 1970 is configured to fill approximately 100% of the second magnet housing portion 1928 that is not filled by the second steel rib 1987. In some embodiments, the magnets 1965, 1970 include two magnets each for filling respective magnet housing portions on either side of the steel ribs 1985, 1987. The steel ribs 1985, 1987 can be similarly implemented in any of the rotors disclosed herein.

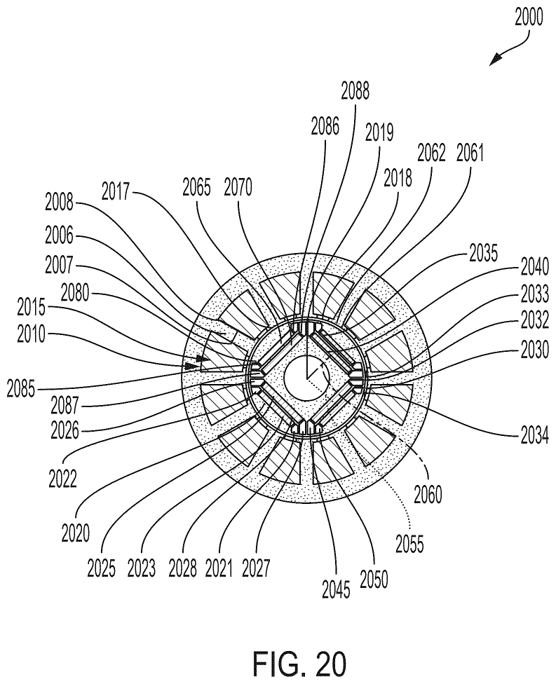

FIG. 20 illustrates a permanent magnet-assisted synchronous reluctance motor 2000 including ribs, according to some embodiments. The motor 1000 includes a stator 2005 and a plurality of stator winding slots 2010. The stator 2005 includes a plurality of stator teeth 2006. The plurality of stator teeth including a stator tooth width 2007 and a stator tooth length 2008. The plurality of stator winding slots 1910 are configured to receive a plurality of windings 1915. The motor 2000 includes a rotor 2017. The rotor 2017 includes a first slot 2020 and a second slot 2025. The first slot 2020 includes a first arm 2021 and a second arm 2022, and a first magnet housing portion 2023 is positioned therebetween. The second slot 2025 includes a first arm 2026 and a second arm 2027, and a second magnet housing portion 2028 is positioned therebetween. The rotor 2017 includes a circumferential outside surface 2018 spaced a first radial distance 2019 away from the center of rotation of the rotor 2017. In some embodiments, the first radial distance 2019 is no more than 90% of a radius of the stator outer diameter.

The first arm 2021 and the second arm 2022 of the first slot 2020 includes a first width 2034 and a first length 2030. In some embodiments, the first width 2034 is between 2.5% and 200% of the first length 2035, and the first length 2030 is between 2 times the airgap thickness and 50% of the first radial distance 2019. The airgap thickness is the distance between a rotor outer diameter 2061 and a stator inner diameter 2062. The first arm 2026 the second arm 2027 of the second slot 2025 includes a first width 2033 and a first length 2032. In some embodiments, the first width 2033 is between 2.5% and 200% of the first length 2040 of the second magnet housing portion 2028, and the first length 2032 is between 2 times the airgap thickness and 50% of the first radial distance 2019.

The first magnet housing portion 2023 includes a first width 2050 and a first length 2035. In some embodiments, the first width 2050 is between 0.5 to 10 times the airgap thickness, and the first length 2035 is larger than the stator tooth width 2007. The first magnet housing portion 2023 includes a first steel rib 2085 positioned between the first arm 2021 of the first slot 2020 and the first magnet housing portion 2023, and a second steel rib 2086 positioned between the second arm 2022 of the first slot 2020 and the first magnet housing portion 2023. In some embodiments, the first steel rib 2085 and the second steel rib 2086 are configured to have a length 2080 and fill a portion of the first magnet housing portion 2023 equal to the length 2080 of the first steel rib 2085 and the second steel rib 2086.

The second magnet housing portion 2028 includes a first width 2045 and a first length 2040. In some embodiments, the first width 2045 is between 0.5 to 10 times the airgap thickness, and the first length 2040 is larger than the stator tooth width 2007. The second magnet housing portion 2028 includes a third steel rib 2087 positioned between the first arm 2026 of the second slot 2025 and the second magnet housing portion 2028, and a fourth steel rib 2088 positioned between the second arm 2027 of the second slot 2025 and the second magnet housing portion 2028. In some embodiments, the third steel rib 2087 and the fourth steel rib 2088 are configured to have a length 2080 and fill a portion of the second magnet housing portion 2028 equal to the length 2080 of the third steel rib 2087 and the fourth steel rib 2088. In some embodiments, the third steel rib 2087 and the fourth steel rib 2088 are configured to have a length 2080 and fill a portion of the second magnet housing portion 2028 equal to the length 2080 of the third steel rib 2087 and the fourth steel rib 2088.

In some embodiments, the first slot 2020 is referred to as an outer slot, and the second slot 2025 is referred to as an inner slot. In some embodiments, the first slot and the second slot are positioned at different radial distances from the center of rotation of rotor 2017. For example, a first slot 2020 is positioned at a second radial distance 2055 from the center of rotation of the rotor 2017, the second radial distance no more than 50 to 95% of the first radial distance 2019, and a second slot 2025 is positioned a third radial distance 2060 from the center of rotation of the rotor 2017, the third radial distance being between 50% and 95% of the first radial distance 2019, and where the second radial distance 2055 is greater than the third radial distance 2060.

The first magnet housing portion 2023 is configured to receive a magnet, such as magnet 2065. In some embodiments, magnet 2065 is configured to fill approximately 100% of the first magnet housing portion 2023 that is not filled by the first steel rib 2085 or the second steel rib 2086. Second magnet housing portion 2028 is configured to receive a magnet, such as magnet 2070. In some embodiments, magnet 2070 is configured to fill approximately 100% of the second magnet housing portion 2028 that is not filled by the third steel rib 2087 or the fourth steel rib 2088. The steel ribs 2085, 2086, 2087, and 2088 can be similarly implemented in any of the rotors disclosed herein.

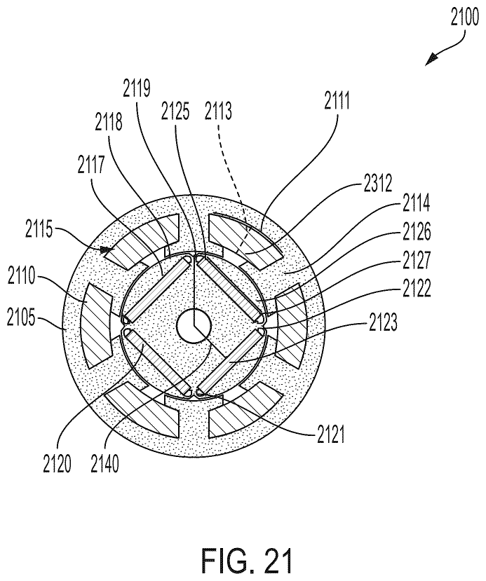

FIG. 21 illustrates an internal permanent magnet motor 2100, according to some embodiments. The motor 2100 includes an outer diameter of between, for example, 60 millimeters and 65 millimeters. In some instances, the outer diameter of the motor 2100 is approximately 63 millimeters. The motor 2100 includes a stator 2105 and a plurality of stator winding slots 2110. The plurality of stator winding slots 2110 are configured to receive a plurality of stator windings 2115. The plurality of windings are wound around one or more of a plurality of stator teeth 2114. The stator winding slots 2110 include an outer stator winding circumference 2111 and an inner stator winding circumference 2112. The outer stator winding circumference 2111 and the inner stator winding circumference 2112 are displaced from each other by a stator winding slot radius 2113. In some examples, the stator winding slots 2110 include a winding gap. For instance, in some examples, the motor 2100 may include an air gap between the plurality of stator windings 2115. In some instances, such as is illustrated in FIG. 21, the plurality of stator windings 2115 do not include a winding gap.

The motor 2100 includes a rotor 2117. The motor 2100 can include pairs of first and second slots for each pole of the rotor 2117 (e.g., four poles, six poles, etc.). In some instances, motor 2100 is also referred to as a 4-pole 6-slot IPM motor. The rotor 2117 includes a circumferential outside surface 2118 spaced a first radial distance 2119 away from the center of rotation of the rotor 2117. The rotor 2117 includes a plurality of slots 2120 configured to receive magnets. In some embodiments, slots 2120 include a first arm 2121 and a second arm 2122, and a magnet housing portion 2123 of the slot positioned therebetween. Magnet housing portion 2123 is configured to be spaced a second radial distance 1540 away from the center of rotation of rotor 2117. Magnet housing portion 2123 is configured to receive a magnet 2125 with a length 2126 and a width 2127. In some embodiments, the magnet 2125 has a length 2126 that fills approximately 100% of the magnet housing portion 2123.

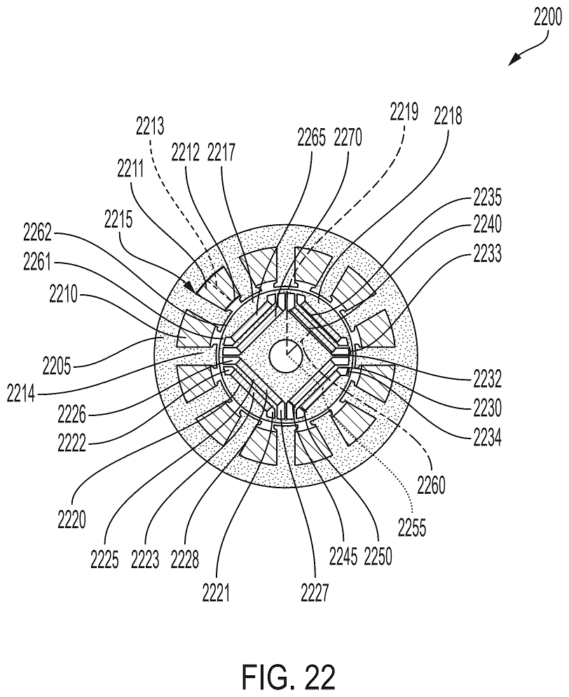

FIG. 22 illustrates a permanent magnet-assisted synchronous reluctance motor 2200, according to some embodiments. The motor 2200 includes an outer diameter of, for example, between 60 millimeters and 65 millimeters. In some instances, the outer diameter of the motor 2200 is approximately 63 millimeters. The motor 2200 includes a stator 2205 and a plurality of stator winding slots 2210. The plurality of stator winding slots 2210 are configured to receive a plurality of windings 2215. The plurality of windings are wound around one or more of a plurality of stator teeth 2214. The stator winding slots 2210 include an outer stator winding circumference 2211 and an inner stator winding circumference 2212. The outer stator winding circumference 2211 and the inner stator winding circumference 2212 are displaced from each other by a stator winding slot radius 2213. The motor 2200 further includes an airgap thickness that is the distance between a rotor outer diameter and a stator inner diameter.

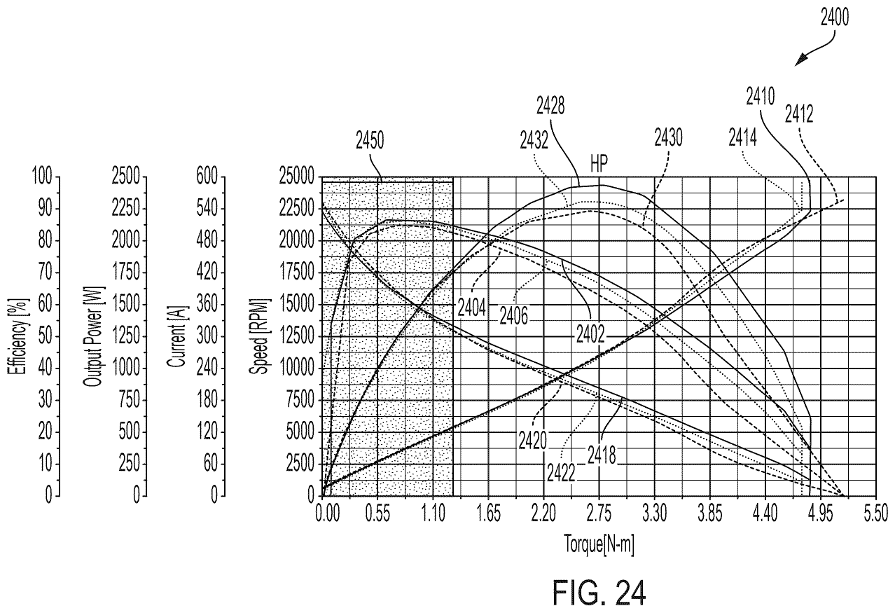

In some examples, the plurality of windings 2215 are configured as distributed windings (e.g., in contrast to concentrated windings). For instance, the plurality of windings 2215 are wound over at least two of the plurality of stator teeth 2214. In this example, the plurality of winding 2215 are divided into a number of smaller coils configured to be evenly distributed around a circumference of the stator core. This advantageously reduces the harmonic distortion in the motor 2200, which may lead to improved efficiency, reduced noise, and other performance improvements illustrated in FIG. 24. Additionally, the distributed plurality of windings 2215 may provide a more uniform distribution of magnetic flux.

The motor 2200 also includes a rotor 2217. The rotor 2217 includes a first slot 2220 and second slot 2225. The first slot 2220 includes a first arm 2221 and a second arm 2222, and a first magnet housing portion 2223 positioned therebetween. The second slot 2225 includes a first arm 2226 and a second arm 2227, and a second magnet housing portion 2228 positioned therebetween. The motor 2200 can include pairs of first and second slots for each pole of the rotor 2217 (e.g., four poles, six poles, etc.).

The rotor 2217 includes a circumferential outside surface 2218, spaced a first radial distance 2219 away from the center of rotation of the rotor. In some embodiments, the first radial distance 2219 is no more than 90% of a radius of the stator outer diameter. The first arm 2221 of the first slot 2220 includes a first width 2234 and a first length 2230. In some embodiments, the first width 2234 is between 2.5% and 200% of the magnet housing width 2245, and the first length 2230 is between 2 times the airgap thickness and 50% of the first radial distance 2219. The airgap thickness is the distance between a rotor outer diameter 2261 and a stator inner diameter 2262. The first magnet housing portion 2223 includes a first width 2250 and a first length 2235.

In some embodiments, the first width 2250 is between 0.5 to 10 times the airgap thickness, and the first length 2235 is larger than a stator tooth width. The first arm 2226 of the second slot 2225 includes a first width 2233 and a first length 2232. In some embodiments, the first width 2233 is between 2.5% and 200% of the magnet housing width 2245, and the first length 2232 is between 2 times the airgap thickness and 50% of the first radial distance 2219. The second magnet housing portion 2228 includes a first length 2240) and a first width 2250). In some embodiments, the first width 2250 is between 0.5 to 10 times the airgap thickness, and the first length 2240 is larger than a stator tooth width.

In some embodiments, the first slot 2220 is referred to as an outer slot, and the second slot 2225 is referred to as an inner slot. In some embodiments, the first slot 2220) and the second slot 2225 are positioned at different radial distances from the center of rotation of rotor 2217. For example, the first slot 2220 is positioned at a second radial distance 2255 from the center of rotation of the rotor 2217. In some embodiments, the second radial distance 2255 is no more than 50% to 95% of the first radial distance 2219, and the second slot 2225 is positioned a third radial distance 2260 from the center of rotation. In some embodiments, the third radial distance is between 50% and 95% of the first radial distance 2219, where the second radial distance 2255 is greater than the third radial distance 2260.

The first magnet housing portion 2223 is configured to receive a magnet, such as a magnet 2265. In some embodiments, the magnet 2265 is configured to fill approximately between 80% and 100% of the first magnet housing portion 2223. Second magnet housing portion 2228 is configured to receive a magnet, such as a magnet 2270. In some embodiments, the magnet 2270) is configured to fill approximately 100% of the second magnet housing portion 2228. In some embodiments, the magnets 2265 and 2270 are rare earth magnets (e.g., neodymium magnets).

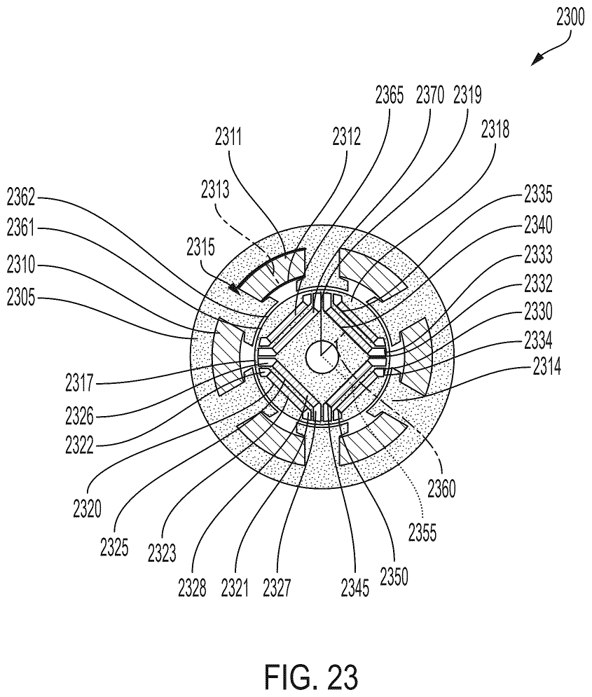

FIG. 23 illustrates a permanent magnet-assisted synchronous reluctance motor 2300, according to some embodiments. The motor 2300 includes an outer diameter of, for example, between 60 millimeters and 65 millimeters. In some instances, the outer diameter of the motor 2300 is approximately 63 millimeters. The motor 2300 includes a stator 2305 and a plurality of stator winding slots 2310. In some examples, the plurality of stator winding slots 2310 includes at least 6 stator slots. The plurality of stator winding slots 2310 are configured to receive a plurality of windings 2315. The plurality of windings are wound around one or more of a plurality of stator teeth 2314. The stator winding slots 2310 include an outer stator winding circumference 2311 and an inner stator winding circumference 2312. The outer stator winding circumference 2311 and the inner stator winding circumference 2312 are displaced from each other by a stator winding slot radius 2313. The motor 2300 further includes an airgap thickness that is the distance between a rotor outer diameter and a stator inner diameter.

In some examples, the plurality of windings 2315 are configured as concentrated windings (e.g., in contrast to distributed windings). For example, the plurality of windings 2315 are wound over only one of the plurality of stator teeth 2314. In contrast to the distributed plurality of windings 2215 of the motor 2200, the plurality of windings 2315 configured as concentrated windings may include a smaller number of coils concentrated in specific areas of the stator 2305. This results in a simpler and more compact construction, which may be less expensive to manufacture than distributed windings.

The motor 2300 includes a rotor 2317. The rotor 2317 includes a first slot 2320 and second slot 2325. The first slot 2320 includes a first arm 2321 and a second arm 2322, and a first magnet housing portion 2323 positioned therebetween. The second slot 2325 includes a first arm 2326 and a second arm 2327, and a second magnet housing portion 2328 positioned therebetween. The motor 2300 can include pairs of first and second slots for each pole of the rotor 2317 (e.g., four poles, six poles, etc.).

The rotor 2317 includes a circumferential outside surface 2318, spaced a first radial distance 2319 away from the center of rotation of the rotor. In some embodiments, the first radial distance 2319 is no more than 90% of a radius of the stator outer diameter. The first arm 2321 of the first slot 2320 includes a first width 2334 and a first length 2330. In some embodiments, the first width 2334 is between 2.5% and 200% of the magnet housing width 2335, and the first length 2330 is between 2 times the airgap thickness and 50% of the first radial distance 2319. The airgap thickness is the distance between a rotor outer diameter 2361 and a stator inner diameter 2362. The first magnet housing portion 2323 includes a first width 2350 and a first length 2340.

In some embodiments, the first width 2350 is between 0.5 to 10 times the airgap thickness, and the first length 2340 is larger than a stator tooth width. The first arm 2326 of the second slot 2325 includes a first width 2333 and a first length 2332. In some embodiments, the first width 2333 is between 2.5% and 200% of the magnet housing width 245, and the first length 2332 is between 2 times the airgap thickness and 50% of the first radial distance 2319. The second magnet housing portion 2328 includes a first length 2340) and a first width 2345. In some embodiments, the first width 2345 is between 0.5 to 10 times the airgap thickness, and the first length 2344 is larger than a stator tooth width.

In some embodiments, the first slot 2320 is referred to as an outer slot, and the second slot 2325 is referred to as an inner slot. In some embodiments, the first slot 2320 and the second slot 2325 are positioned at different radial distances from the center of rotation of rotor 2317. For example, the first slot 2320 is positioned at a second radial distance 2355 from the center of rotation of the rotor 2317. In some embodiments, the second radial distance 2355 is no more than 50% to 95% of the first radial distance 2319, and the second slot 2325 is positioned a third radial distance 2360 from the center of rotation. In some embodiments, the third radial distance is between 50% and 95% of the first radial distance 2319, where the second radial distance 2355 is greater than the third radial distance 2360).

First magnet housing portion 2323 is configured to receive a magnet, such as a magnet 2365. In some embodiments, the magnet 2365 is configured to fill approximately between 80% and 100% of the first magnet housing portion 2323. Second magnet housing portion 2228 is configured to receive a magnet, such as a magnet 2370. In some embodiments, the magnet 2370) is configured to fill approximately 100% of the second magnet housing portion 2328. In some embodiments, the magnets 2365 and 2370 are rare earth magnets (e.g., neodymium magnets). In some embodiments, each of the motors 2200, 2300 has an approximately 10% reduced magnet mass when compared with motor 2100.

FIG. 24 is a graphical representation of efficiency, electrical current, and speed in revolutions per minute (“RPM”) compared to torque outputs of several different motors in the power tool 100, in accordance with some embodiments. In some embodiments, the motor represented in graph 2400 is the motor of a core drill. The graph 2400 includes a representation of the efficiency of several different motors within the power tool 100. A curve 2402 illustrates an efficiency of one type of motor of the power tool 100, such as the motor 2100. A curve 2404 illustrates an efficiency of a second type of motor of the power tool 100, such as motor 2200. A curve 2406 illustrates an efficiency of a third type of motor of the power tool 100, such as motor 2300. In some embodiments, the curve 2402 is the efficiency of motor 2100 as torque values increase. In some embodiments, the curve 2404 is the efficiency of motor 2300 as torque values increase. In some embodiments, the efficiency of motor 2300 diminishes at a faster rate than motor 2100 for a given torque value. In some embodiments, the curve 2406 is the efficiency of motor 2300 as torque values increase. In some embodiments, the efficiency of motor 2200 diminishes at a faster rate than motor 2100 and motor 2300 for a given torque value.

Graph 2400 additionally includes a representation of the electrical current of several different motors within the power tool 100. A curve 2410 illustrates an electrical current of one type of motor of the power tool 100, such as motor 2100. A curve 2412 illustrates an electrical current of a second type of motor of the power tool 100, such as motor 2200. A curve 2414 illustrates an electrical current of a third type of motor of the power tool 100, such as motor 2300. In some embodiments, the curve 2410 is the electrical current level of motor 2100 as torque values increase. In some embodiments, the curve 2412 is the electrical current of motor 2200 as torque values increase. In some embodiments, as torque increases, the electrical current of both motor 2200 and motor 2300 is approximately equal for a given torque value. In some embodiments, the curve 2414 is the electrical current of motor 2300 as torque values increase. In some embodiments, as torque increases, the electrical current of motor 2100, motor 2200, and 2300 are approximately equal to each other until approximately 3.5 Nm of torque.

Graph 2400 additionally includes a representation of the RPM of several different motors within the power tool 100. A curve 2418 illustrates an RPM of one type of motor of the power tool 100, such as motor 2100. A curve 2420 illustrates an RPM of a second type of motor of the power tool 100, such as motor 2200. A curve 2422 illustrates an RPM of a third type of motor of the power tool 100, such as motor 2300. In some embodiments, the curve 2418 is the RPM level of motor 2100 as torque values increase. In some embodiments, the curve 2420 is the RPM of motor 2200 as torque values increase. In some embodiments, as torque increases, the RPM of motor 2200 starts at a higher level and then diminishes at a faster rate than the RPM of motor 2100 for a given torque value. In some embodiments, the curve 2422 is the RPM of motor 2300 as torque values increase. In some embodiments, as torque increases, the RPM of motor 2300 starts at a higher level and then diminishes at a faster rate than the RPM of motor 2100 for a given torque value. In some embodiments, for the operating load 2450 of the power tool 100, each motor operates at approximately the same speed.

Graph 2400 additionally includes a representation of the output power, in Watts, of several different motors within the power tool 100. A curve 2428 illustrates an output power of one type of motor of the power tool 100, such as motor 2100. A curve 2430 illustrates an output power of a second type of motor of the power tool 100, such as motor 2200. A curve 2432 illustrates an output power of a third type of motor of the power tool 100, such as motor 2300. In some embodiments, the curve 2428 is the output power level of motor 2100 as torque values increase. In some embodiments, the curve 2430 is the output power level of motor 2200 as torque values increase. In some embodiments, the curve 2432 is the output power level of motor 2300 as torque values increase. In some embodiments, for the operating load 2450 of the power tool 100, each motor 2100, 2200, 2300 operates at approximately the same output power level. For various embodiments described herein, a distance between two adjacent rotor arms is less than the magnet thickness. For various embodiments described herein, a distance between two adjacent arms is less than 200% the magnet thickness. For various embodiments described herein, a plurality of stator windings may be configured as distributed windings or concentrated windings.

Additionally, each of the rotor configurations described herein can be used with either a distributed winding stator or a concentrated winding stator. In some embodiments, each of the rotor configurations can be used with a segmented stator or a non-segmented stator.

Thus, embodiments described herein provide a power tool including a permanent magnet-assisted synchronous reluctance motor. Various features and advantages are set forth in the following claims.

1. A power tool comprising:
a battery pack interface configured to receive a removable and rechargeable battery pack; and
a permanent magnet assisted synchronous rotor motor including:
a stator including a plurality of stator teeth configured to receive a plurality of stator coils, and a rotor including:
a first slot located between an external circumferential surface of the rotor, the first slot including a first magnet housing portion, the first magnet housing portion having a first width and a first length, the first magnet housing portion located a first radial distance away from a center of rotation of the rotor, a second slot located between the external circumferential surface of the rotor and the first slot, the second slot including a second magnet housing portion, the second magnet housing portion having a second width and a second length, the second length of the second slot being shorter than the first length of the first slot, and the second magnet housing located a second radial distance away from the center of rotation of the rotor,
a first magnet within the first magnet housing portion, the first magnet having a first magnet length and a first magnet width,
a second magnet within the second magnet housing, the second magnet having a second magnet length and a second magnet width, and
wherein the first magnet fills at least 60% of the first magnet housing portion and the second magnet fills at least 60% of the second magnet housing portion, and
wherein the first magnet fills at least as much of the first magnet housing portion as the second magnet fills the second magnet housing portion.

2. The power tool of claim 1, wherein:
the stator includes at least twelve stator slots; and
the rotor includes at least four rotor poles.

3. The power tool of claim 1, wherein:
the first magnet is composed of a ferrite metal material; and
the second magnet is composed of a rare earth metal material.

4. The power tool of claim 1, wherein the second magnet fills a greater percentage of the second magnet housing portion than the first magnet fills the first magnet housing portion.

5. The power tool of claim 1, further comprising:
a first steel rib associated with the first slot; and
a second steel rib associated with the second slot.

6. A power tool comprising:
a battery pack interface configured to receive a removable and rechargeable battery pack; and
a permanent magnet assisted synchronous rotor motor including:
a stator including a plurality of stator teeth configured to receive a plurality of stator coils, and
a rotor including:
a first slot located between an external circumferential surface of the rotor, the first slot including a first magnet housing portion, the first magnet housing portion having a first width and a first length, the first magnet housing portion located a first radial distance away from a center of rotation of the rotor,
a second slot located between the external circumferential surface of the rotor and the first slot, the second slot including a second magnet housing portion, the second magnet housing portion having a second width and a second length, the second length of the second slot being shorter than the first length of the first slot, and the second magnet housing located a second radial distance away from the center of rotation of the rotor,
a first magnet within the first magnet housing portion, the first magnet having a first magnet length and a first magnet width,
a second magnet within the second magnet housing, the second magnet having a second magnet length and a second magnet width, and
wherein the first magnet fills between 60% and 90% of the first magnet housing portion and the second magnet fills between 60% and 90% of the second magnet housing portion, and
wherein the first magnet fills at least as much of the first magnet housing portion as the second magnet fills the second magnet housing portion.

7. The power tool of claim 6, wherein:
the stator includes at least eighteen stator slots; and
the rotor includes at least six rotor poles.

8. The power tool of claim 6, wherein:
the stator includes at least six stator slots; and
the rotor includes at least four rotor poles.

9. The power tool of claim 6, wherein:
the first magnet is composed of a ferrite metal material; and
the second magnet is composed of a rare earth metal material.

10. The power tool of claim 6, wherein the first magnet and the second magnet are composed of a rare earth metal material.

11. The power tool of claim 6, wherein the second magnet fills a greater percentage of the second magnet housing portion than the first magnet fills the first magnet housing portion.

12. A power tool comprising:
a battery pack interface configured to receive a removable and rechargeable battery pack; and
a permanent magnet assisted synchronous rotor motor including:
a stator including a plurality of stator teeth configured to receive a plurality of stator coils, and
a rotor including:
a first slot located between an external circumferential surface of the rotor, the first slot including a first magnet housing portion, the first magnet housing portion having a first width and a first length, the first magnet housing portion located a first radial distance away from a center of rotation of the rotor,
a second slot located between the external circumferential surface of the rotor and the first slot, the second slot including a second magnet housing portion, the second magnet housing portion having a second width and a second length, the second length of the second slot being shorter than the first length of the first slot, and the second magnet housing located a second radial distance away from the center of rotation of the rotor,
a first magnet within the first magnet housing portion, the first magnet having a first magnet length and a first magnet width,
a second magnet within the second magnet housing, the second magnet having a second magnet length and a second magnet width,
a first steel rib configured to fill a portion of the first magnet housing portion,
a second steel rib configured to fill a portion of the second magnet housing portion, and
wherein the first magnet fills least 60% of the first magnet housing portion and the second magnet fills at least 60% of the second magnet housing portion, and
wherein the first magnet fills at least as much of the first magnet housing portion as the second magnet fills the second magnet housing portion.

13. The power tool of claim 12, wherein:
the first steel rib is positioned at the center of the first magnet housing portion; and
the second steel rib is positioned at the center of the second magnet housing portion.

14. The power tool of claim 12, the power tool further comprising a third steel rib and a fourth steel rib.

15. The power tool of claim 14, wherein:
the first steel rib is configured to be positioned between a first arm of the first slot and the first magnet housing portion;
the second steel rib is configured to be positioned between a second arm of the first slot and the first magnet housing portion;
the third steel rib is configured to be positioned between a first arm of the second slot and the second magnet housing portion; and
wherein the fourth steel rib is configured to be positioned between a second arm of the second slot and the second magnet housing portion.

16-40. (canceled)
